(19) United States
(12) Patent Application Publication
(10) Pub. No.: US 2013/0325567 A1
(43) Pub. Date: Dec. 5, 2013

(54) SYSTEM AND METHOD FOR CREATING A VIRTUAL COUPON

(71) Applicant: Augme Technologies, Inc., New York, NY (US)

(72) Inventors: Nathaniel T. Bradley, Tucson, AZ (US); Jim G. Crawford, Fall City, WA (US); Joshua S. Paugh, Tucson, AZ (US); Douglas F. Bender, Scotts Valley, CA (US)

(73) Assignee: Augme Technologies, Inc., New York, NY (US)

(21) Appl. No.: 13/774,418

(22) Filed: Feb. 22, 2013

Related U.S. Application Data
(60) Provisional application No. 61/602,828, filed on Feb. 24, 2012.

(51) Int. Cl. G06Q 30/02

(52) U.S. Cl. CPC G06Q 30/0207
USPC 705/14.1; 705/14.26

(57) ABSTRACT

The system and method of creating virtual coupons from physical coupons. The user engages a physical coupon by scanning a multi-modal artifact or code from the physical coupon with a digital device. The physical coupon can be a printed coupon or advertisement, a media broadcast (such as television, radio, internet, etc.), and/or the like. The digital device may be a smartphone, tablet, laptop, smart remote, e-reader, and/or the like, which is capable of capturing multi-modal artifacts or codes, or running a computer-implemented software program to create and retrieve virtual coupons.

### CROSS-REFERENCE TO RELATED APPLICATIONS

The present invention claims priority to U.S. Provisional Application Ser. No. 61/602,828, filed Feb. 24, 2012 and is related to co-pending, commonly assigned U.S. Patent Application Publication No. US 2011/0264527A (the '527 Published Application), both of which are hereby incorporated in their entirety by reference.

### BACKGROUND OF THE INVENTION

The present invention relates generally to systems and method for creating virtual coupons from physical coupons.

Existing technologies in which 2-D images are captured and utilized for comparisons to a data store for subsequent action/response based on the application of the existing technology. For example, when a person is fingerprinted (e.g., taken to jail for booking) their fingerprints are taken and are often then processed for analysis by the AFIS/IAFIS system which returns a response as to the history associated with the submitted fingerprints. In this example the fingerprints get scanned at the jail and submitted to the AFIS/IAFIS system for analysis. This is an example of 2-D scanning of a physical representation of the fingerprints (fingerprint data sheet—i.e., paper) which converts them to an electronic form for analysis.

Where this invention departs from this current technology is its capabilities of multi-modal data capture, integration with a data service for purposes of facilitating a purchase or related services (e.g., advertisements, coupons, virtual coupons, SMS messaging, etc.), converting or rendering of a physical single or multi-modal artifact (such as a printed coupon found in a magazine) into a virtual coupon or artifact for subsequent processing, and the transmission of the virtual coupon for purposes of purchasing a product or service of interest.

Existing technology does not allow a user to create virtual coupons from physical coupons, and redeem the virtual coupon at merchant in the same manner as the physical coupon, such as through the use of a “coupon wallet” that stores the virtual coupons for the user.

The present invention attempts to solve these problems as well as others.

### SUMMARY OF THE INVENTION

Methods and systems are provided herein for creating a virtual coupon from a physical coupon. The user engages a physical coupon by scanning a multi-modal artifact or code from the physical coupon with a digital device. The physical coupon can be a printed coupon or advertisement, a media broadcast (such as television, radio, internet, etc.), and/or the like. The digital device may be a smartphone, tablet, laptop, smart remote, e-reader, and/or the like, which is capable of capturing multi-modal artifacts or codes, or running a computer-implemented software program to create and retrieve virtual coupons.

A user's digital device allows users to engage (“scan”) artifacts from the physical coupon. In some embodiments, a multi-modal image recognition application allows for the capture of data that can be representative of a sensory input, or be digitally encoded information. The digitally encoded data could represent a barcode, a 2D code, a 3D code, a 3D-VR code, a matrix code, a data matrix, video, audio, a QR code, or other such symbologies. Captured multi-modal artifact data may alternatively be representative of a pure image, a Near Field Communications (NFC) tag, the selection of an internet link by the user, Radio Frequency Identification (RFID) tag, Bluetooth, Infrared, wireless communication, a software input, or the like.

The virtual coupon may be communicated from a data repository or server, which acts upon the multi-modal artifact and returns a reply message to the user's digital device. In one embodiment, the communicated data further comprises a user ID, a hardware ID, a geocode, a timestamp, a subject code, a source code, and/or a content code. In some embodiments, the server is a code triggered information server (CTIS). The reply message may include, but is not limited to: a virtual coupon associated with the scanned multi-modal artifact, a discount code associated with the scanned multi-modal artifact, or a user query associated with the scanned multi-modal artifact. In one embodiment, the reply message communicates a query to the user's digital device, prompting the user whether he or she wants to redeem the virtual coupon at that time. If so, the server will communicate the virtual coupon to the user's digital device for immediate redemption. If the user responds that he or she does not wish to redeem the virtual coupon immediately, the virtual coupon will be stored for subsequent redemption. The virtual coupon may be stored in different manners, depending on the embodiment of the invention. In one embodiment, the virtual coupon is stored in the local storage of the user's digital device. In another embodiment, the virtual coupon is stored in a second data repository, such as a “coupon wallet” associated with a user profile unique to the user.

When a user subsequently requests a stored virtual coupon, either from the digital device's local storage or the coupon wallet, the server will query the user as to which virtual coupon is being retrieved. Once selected, the virtual coupon will be retrieved from local storage or the coupon wallet, and communicated to the user's digital device. The user's digital device can then interface with a point of sale system, to communicate the virtual coupon to the point of sale system. The point of sale system may be associated with a 3^{rd} party system. The communication of the virtual coupon to the point of sale system may be by Near Field Communication (NFC), infrared (IR), Short Message Service (SMS), Multimedia Messaging Service (MMS), instant messaging, web browser based messaging, email, Enhanced Messaging System, TCP/IP, WAP, barcode, and/or the like. Once the virtual coupon is transmitted to the point of sale system, the user is able to complete a transaction redeeming the virtual coupon. In one embodiment, the virtual coupon is removed from local storage or the coupon wallet after redemption by the user. In another embodiment, alternative digital rights management (DRM) software may be used to prevent coupon copying, sharing, and/or the like. In another embodiment, there is no DRM software or deletion of the virtual coupon.

In one embodiment of the invention, the user is notified of a stored virtual coupon previously created from a physical coupon. The notification of the user of the stored virtual coupon occurs when a condition is satisfied. The condition may, without limitation, be: a date, the current location of the user, a predicted location of the user, a second multi-modal artifact scanned by the user, based on a user profile, and/or the like. After notification, the virtual coupon in question may be retrieved by the user as described above.

In some embodiments of the invention, a fee may be recorded based on the user response to the reply message, based on the communication of a virtual coupon to a point of sale system, based on the user response to a notification of a stored virtual coupon, and/or the like.

Embodiments of the present invention also exist where the virtual coupon is created by an application on the digital device. This application may or may not communicate with a data repository or server to create the virtual coupon.

### BRIEF DESCRIPTION OF THE DRAWINGS

The accompanying appendices and/or drawings illustrate various non-limiting, example, inventive aspects in accordance with the present disclosure:

FIG. 1 shows a combined logic and data flow block diagram illustrating a general overview of embodiments of a system and method for creating and utilizing virtual coupons;

FIG. 2 shows a combined logic and data flow block diagram illustrating a code triggered information server (“CTIS”) for rendering and delivering/storing virtual coupons;

FIG. 3 shows a combined logic and data flow block diagram illustrating retrieval/delivery of a stored virtual coupon for redemption by a user at a point of sale;

FIG. 4 shows an implementation of combined logic and data flow in an embodiment of the invention, optionally employing image enhancement techniques;

FIG. 5 shows a combined logic and data flow block diagram for an exemplary embodiment of the present invention;

FIG. 6 shows user trajectories through a network of 3^{rd} party virtual coupon provider zones;

FIG. 7 shows an embodiment of the web interface for user registration;

FIG. 8a shows three types of 2D barcodes that may be employed within the CTIS; FIGS. 8b-c show logic flow for coupon code/artifact enhancement in one embodiment of CTIS operation; FIG. 8d shows an implementation of logic flow for customized repair and/or decoding of obscure or ambiguous coupon codes/artifact;

FIG. 9 shows an illustration of one embodiment of the Scan Message data structure;

FIGS. 10a-b show an illustration of one embodiment of a user profile data structure and an implementation of a user profile user interface in one embodiment of GCSI/CTIS operation;

FIG. 11 shows a logic flow diagram of one embodiment of the user profile query heuristic;

FIG. 12 shows an exemplary histogram of 3^{rd} party virtual coupon provider zone breaches;

FIG. 13 shows an illustration of one embodiment of the Information Base (Virtual Coupon) data structure;

FIGS. 14a-d show some embodiments of systems for selecting non-triggered information and/or virtual coupons to serve to users;

FIGS. 15a-b show examples of virtual coupons provided by the CTIS;

FIG. 16 shows an implementation of a user interface manifesting GCSI/CTIS functionality on digital paper in one embodiment of GCSI/CTIS operation;

FIG. 17 shows an illustration of media sampling and full media acquisition in one embodiment of GCSI/CTIS operation;

FIGS. 18a-b show an implementation of logic flow for code scan monetization in one embodiment of GCSI/CTIS operation;

FIGS. 19a-e show aspects of implementations of JagTag encoding and codes in some embodiments of GCSI/CTIS operation;

FIG. 20 shows a computer systemization of the GCSI/CTIS; and

FIG. 21a is a block diagram illustrating a CTIS configured to assign users having similar interests and situation information into dynamic groups according to an embodiment; and FIG. 21b is a block diagram illustrating a CTIS configured to identify profile elements that are related to specific content according to an embodiment.

### DETAILED DESCRIPTION OF THE INVENTION

### DEFINITIONS & TERMINOLOGY

### Servers, Computers, Clients, Networks, Routers

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

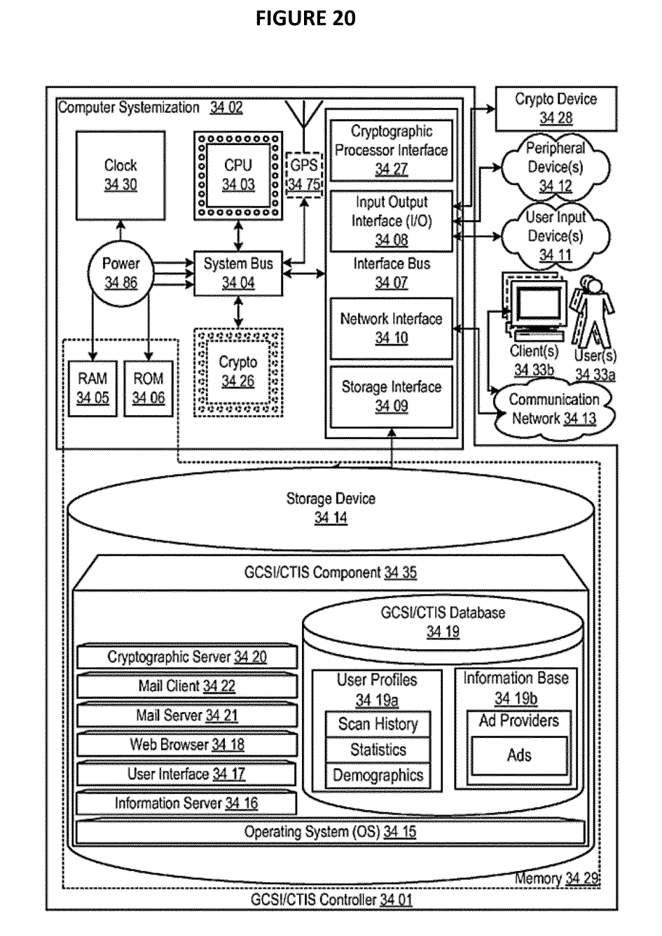

In one embodiment, the code triggered information server controller 3401 may be connected to and/or communicate with entities such as, but not limited to: one or more users from user input devices 3411; peripheral devices 3412; a cryptographic processor device 3428; and/or a communications network 3413, as shown in FIG. 20.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The code triggered information server controller 3401 may be based on common computer systems that may comprise, but are not limited to, components such as: a computer systemization 3402 connected to memory 3429.

### Computer Systemization

A computer systemization 3402 may comprise a clock 3430, central processing unit (CPU) 3403, a read only memory (ROM) 3406, a random access memory (RAM) 3405, and/or an interface bus 3407, and most frequently, although not necessarily, are all interconnected and/or communicating through a system bus 3404, as shown in FIG. 20. Optionally, the computer systemization may be connected to an internal power source 3486. Optionally, a cryptographic processor 3426 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 3486 may be of any standard form for powering small electronic circuit board devices such as the following power cells: alkaline, lithium hydride, lithium ion, lithium polymer, nickel cadmium, solar cells, and/or the like, as shown in FIG. 20. Other types of AC or DC power sources may be used as well. In the case of solar cells, in one embodiment, the case provides an aperture through which the solar cell may capture photonic energy. The power cell 3486 is connected to at least one of the interconnected subsequent components of the code triggered information server thereby providing an electric current to all subsequent components. In one example, the power source 3486 is connected to the system bus component 3404. In an alternative embodiment, an outside power source 3486 is provided through a connection across the I/O interface 3408. For example, a USB and/or IEEE 1394 connection carries both data and power across the connection and is therefore a suitable source of power.

### Interface Adapters

Interface bus(ses) 3407 may accept, connect, and/or communicate to a number of interface adapters, conventionally although not necessarily in the form of adapter cards, such as but not limited to: input output interfaces (I/O) 3408, storage interfaces 3409, network interfaces 3410, and/or the like, as shown in FIG. 20. Optionally, cryptographic processor interfaces 3427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3409 may accept, communicate, and/or connect to a number of storage devices such as, but not limited to: storage devices 3414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3410 may accept, communicate, and/or connect to a communications network 3413. Through a communications network 3413, the code triggered information server controller is accessible through remote clients 3433b (e.g., computers with web browsers) by users 3433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 3410 may be used to engage with various communications network types 3413. For example, multiple network interfaces may be employed to allow for the communication over broadcast, multicast, and/or unicast networks.

Input Output interfaces (I/O) 3408 may accept, communicate, and/or connect to user input devices 3411, peripheral devices 3412, cryptographic processor devices 3428, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 3411 may be card readers, dongles, finger print readers, gloves, graphics tablets, joysticks, keyboards, mouse (mice), remote controls, retina readers, trackballs, trackpads, and/or the like.

Peripheral devices 3412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors 3426, interfaces 3427, and/or devices 3428 may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information are regarded as memory 3429, as shown in FIG. 20. However, memory is a fungible technology and resource, thus, any number of memory embodiments may be employed in lieu of or in concert with one another. It is to be understood that the code triggered information server controller and/or a computer systemization may employ various forms of memory 3429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 3429 will include ROM 3406, RAM 3405, and a storage device 3414. A storage device 3414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 3429 may contain a collection of program and/or database components and/or data such as, but not limited to: operating system component(s) 3415 (operating system); information server component(s) 3416 (information server); user interface component(s) 3417 (user interface); Web browser component(s) 3418 (Web browser); database(s) 3419; mail server component(s) 3421; mail client component(s) 3422; cryptographic server component(s) 3420 (cryptographic server); the code triggered information server component(s) 3435; and/or the like (i.e., collectively a component collection), as shown in FIG. 20. These components may be stored and accessed from the storage devices and/or from storage devices accessible through an interface bus. Although non-conventional program components such as those in the component collection, typically, are stored in a local storage device 3414, they may also be loaded and/or stored in memory such as: peripheral devices, RAM, remote storage facilities through a communications network, ROM, various forms of memory, and/or the like.

### Operating System

The operating system component 3415 is an executable program component facilitating the operation of the code triggered information server controller, as shown in FIG. 20. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network 3413. Various communication protocols may be used by the code triggered information server system controller as a subcarrier transport mechanism for interaction, such as, but not limited to: multicast, TCP/IP, UDP, unicast, and/or the like.

The operating system component 3415 may also be a mobile operating system, mobile OS, such as iOS (Apple), ANDROID, WINDOWS PHONE (Microsoft), WINDOWS PHONE 7 (Microsoft), BLACKBERRY OS (RIM), WebOS (Hewlett-Packard), MEEGO or SYMBIAN, for example. The mobile OS may be a manufacture-built proprietary operating system, a third party proprietary, or an open source operating system. Mobile OS's are employed on a wide variety of mobile devices useful with the present invention, such as smartphones and tablet computers.

### Information Server

An information server component 3416 is a stored program component that is executed by a CPU, as shown in FIG. 20. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database 3419, operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua or Lion, Microsoft's Windows XP, Windows 7 or Unix's X-Windows provide a baseline and means of accessing and displaying information graphically to users. Mobile OS's, discussed above, also typically employ GUIs, but may also be text-based, and provide user interfaces to mobile devices.

A user interface component 3417, whether on a desktop or laptop computing device or a mobile device, is a stored program component that is executed by a CPU, as shown in FIG. 20. The user interface may be a conventional graphic user interface as provided by, with, and/or atop operating systems and/or operating environments such as those operating systems discussed above, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3418 is a stored program component that is executed by a CPU, as shown in FIG. 20. The Web browser may be a conventional hypertext viewing application such as Microsoft Internet Explorer or Netscape Navigator. Secure Web browsing may be supplied with 128-bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

### Mail Server

A mail server component 3421 is a stored program component that is executed by a CPU 3403, as shown in FIG. 20. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3422 is a stored program component that is executed by a CPU 3403, as shown in FIG. 20. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3420 is a stored program component that is executed by a CPU 3403, cryptographic processor 3426, cryptographic processor interface 3427, cryptographic processor device 3428, and/or the like, as shown in FIG. 20. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Code Triggered Information Server Database

The code triggered information server database component 3419 may be embodied in a database and its stored data, as shown in FIG. 20. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the code triggered information server database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database 3419 may be integrated into another component such as the code triggered information server component 3435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 3419 includes several tables 3419a,b. A user profile table 3419a includes fields such as, but not limited to: a user ID, name, email address, address, demographic profile, hardware ID, scan history record, scan statistics, and/or the like. The user profile table may support and/or track multiple entity accounts on a code triggered information server. An Information Base table 3419b includes fields such as, but not limited to: 3^{rd} party provider ID, 3^{rd} party ID, 3^{rd} party preference content, preference labels, geographic tags, temporal tags, subject tags, preference ratings, preference statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3419a,b. The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

### The Code Triggered Information Server

The code triggered information server component 3435 is a stored program component that is executed by a CPU, as shown in FIG. 20. The code triggered information server affects accessing, obtaining and the provision of information, preferences, services, transactions, and/or the like across various communications networks.

The code triggered information server component enables the identification, generation, and aggregation of Scan Messages and Reply Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, preferences, and/or responses.

### Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

### Code Triggered Information Server Controller

FIG. 20 of the present disclosure illustrates inventive aspects of a code triggered information server controller 3401 in a block diagram. In this embodiment, the code triggered information server controller 3401 may serve to aggregate, process, store, search, serve, identify, instruct, generate, match, and/or update Scan Messages, Reply Messages, Virtual Coupons, user profiles, and/or other related data.

### Point-of-Sale Systems and Devices or Point-of-Purchase Systems

Point of sale (POS) (also sometimes referred to as Point of purchase (POP)) or checkout is the location where a transaction occurs. A “checkout” refers to a POS terminal or more generally to the hardware and software used for checkouts, the equivalent of an electronic cash register. A POS terminal manages the selling process by a salesperson accessible interface. The same system allows the creation and printing of the receipt.

Computerized POS systems and interconnecting POS devices. OPOS (OLE for POS) was the first commonly-adopted standard and was created by Microsoft, NCR Corporation, Epson and Fujitsu-ICL. OPOS is a COM-based interface compatible with all COM-enabled programming languages for Microsoft Windows. OPOS was first released in 1996. JavaPOS was developed by Sun Microsystems, IBM, and NCR Corporation in 1997. JavaPOS is for Java what OPOS is for Windows, and thus largely platform independent. Computerized POS systems may connect to the internet or to the CTIS server and database to retrieve coupons, promotional codes, discount codes, etc.

There are several communication protocols POS systems use to control peripherals. Among them are: EPSON Esc/POS, UTC Standard, UTC Enhanced, AEDEX, ICD 2002, Ultimate, CD 5220, DSP-800, ADM 787/788, HP. A checkout system generally involves the following components: General computer hardware, General computer software, Checkout hardware, Checkout software, miscellaneous store hardware.

Most POS peripherals, such as displays and printers, support several of these command protocols in order to work with many different brands of POS terminals and computers. POS peripherals may be enabled by scan coding, Near Field Communications, Infrared, Bluetooth, or other multi-modal artifact scanning abilities for virtual coupons, discussed further below.

### Scan and Reply Messages for Virtual Coupons

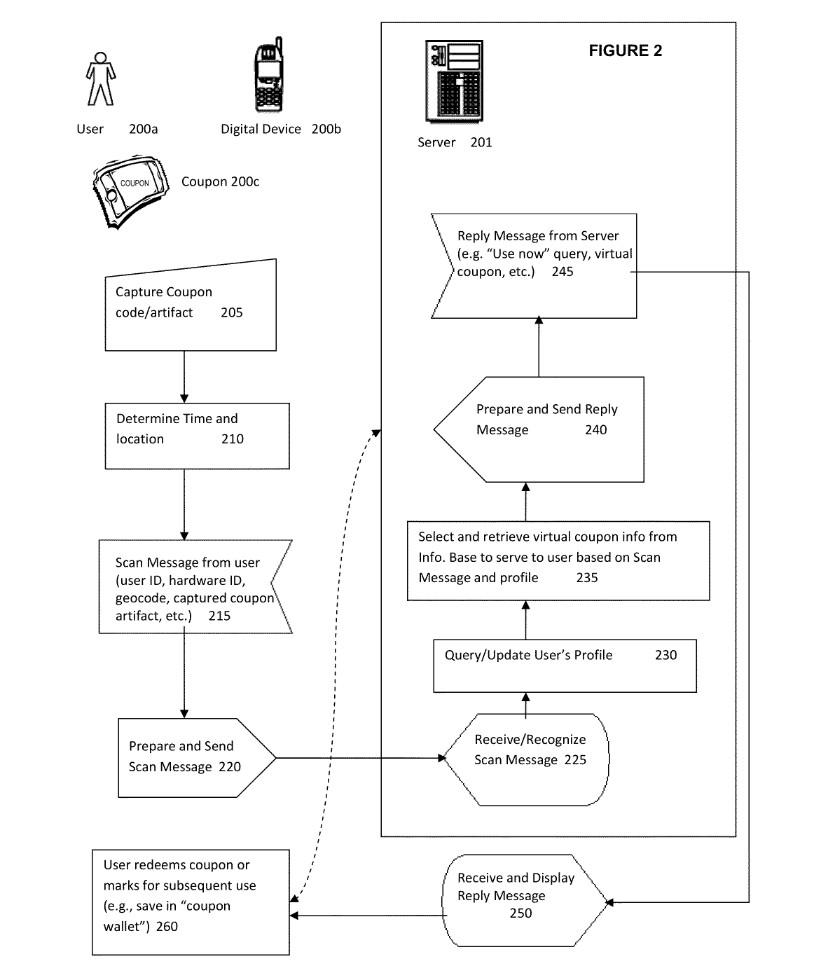

In one embodiment, a code triggered information server (CTIS) employs two basic actors: (i) a user (200a) capable of registering interest in an activity, transmitting and receiving data, and displaying information and virtual coupons; and (ii) a server (201) capable of communicating with the user, storing/updating user profiles, and selecting information and virtual coupons to serve to the user, as shown in FIG. 2. In addition to the two basic actors, the CTIS enables the creation of two types of transactional articles: i) Scan Messages (215) and ii) Reply Messages (245). The CTIS provides context-specific Reply Messages in response to Scan Messages, which are prepared in response to the registration of activity interest by the user, such as scanning coupons, in order to supply virtual coupons to the user. The CTIS generates Reply Messages by processing Scan Message content with user profile information, containing basic profiling data as well as a history of Scan Messages supplied by a given user. As such, Reply Messages are transactional articles that heighten a provider's opportunity to supply relevant and targeted information and/or virtual coupons to the user that are both context and user specific. Without loss of generality, we will heretofore refer to the information and/or virtual coupon content of Reply Messages as “Virtual Coupons.”

### “Registering” Interest (Scanning)

In one embodiment, users of the CTIS scan coupon codes/artifacts to register interest and the CTIS acts as a portal for consumers to access virtual coupons supplemental to the context in which the coupon codes/artifacts are found. Users may scan coupon codes/artifacts found in printed coupons, media publications, on billboards or signs, on consumer products or packages, on websites or television screens, and/or the like. In doing so, the users may identify themselves via an identification code specific to the mobile device and service account with which the scan is made. At the same time, the scanned coupon code/artifact can be recorded, as well as the time of day and user location; such information may form the basis of consumer profiles that may be saved by the CTIS. As these scans are indicative of interest in various subjects, goods, and/or services, they may serve as a basis for an individual customer tracking system. As such, coupon or discount providers can finely tune and efficiently tailor their efforts towards achieving maximum return on the couponing or discount expenditure. Without loss of generality, coupon or discount providers will heretofore be referred to as “Virtual Coupon providers,” “marketers,” or “discount providers.”

### Artifact Capture and Artifact Creation

Artifacts capable of being capture include, among other things, 3D barcodes that are have regions of differing heights, with the regions, their patterns and their relative heights being representative of data. In accordance with one embodiment of the present invention, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The present invention may be used with sight impaired individuals to capture sensory data otherwise unavailable or difficult to access to such individuals and convert the sensory data into a usable form, e.g., sounds. Similarly, in accordance with another embodiment of the invention, a hearing impaired individual may use the present invention to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the present invention may be employed to simply capture and convert data existent in one sensory form to another sensory form that is more useful or available to a user having a particular disability or impairment.

The data captured may be single mode or multi-modal data, and may consist, for example of any sensory-type input, e.g., visual, auditory, olfactory, haptics or gustatory. Visual inputs may consist of image capture, pattern recognition, text recognition, bar codes (such as UPC or QR codes), hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements. Tactile inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference.

In one embodiment, the data capture device 100b may be in the proximity contact with the coupon code/artifact of interest, such as Near Field Communications (NFC), Radio Frequency Identification (RFID), Bluetooth, Infrared, Wireless communication, Automatic Identification and Data Capture (AIDC), and other short range communications and the like. AIDC refers to the methods of automatically identifying objects, collecting data about them, and entering that data directly into computer systems (i.e. without human involvement). Technologies typically considered as part of AIDC include bar codes, Radio Frequency Identification (RFID), biometrics, magnetic stripes, Optical Character Recognition (OCR), smart cards, and voice recognition. AIDC is the process or means of obtaining external data, particularly through analysis of images, sounds or videos. To capture data, a transducer is employed which converts the actual image or a sound into a digital file. The file is then stored and at a later time it can be analyzed by a computer, or compared with other files in a database to verify identity or to provide authorization to enter a secured system. Capturing of data can be done in various ways; the best method depends on application. AIDC also refers to the methods of recognizing objects, getting information about them and entering that data or feeding it directly into computer systems without any human involvement. Automatic identification and data capture technologies include barcodes, RFID, bokodes, OCR, magnetic stripes, smart cards and biometrics (like iris and facial recognition system).

The user registering interest by coupon codes/artifacts capable of being captured include, among other things, 3D barcodes that are have regions of differing heights, with the regions, their patterns and their relative heights being representative of data. In accordance with one embodiment, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The embodiments disclosed herein may be used with sight impaired individuals to capture sensory data otherwise unavailable or difficult to access to such individuals and convert the sensory data into a usable form, e.g., sounds. Similarly, in accordance with another embodiment, a hearing impaired individual may use the embodiments disclosed herein to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the embodiments disclosed herein may be employed to simply capture and convert data existent in one sensory form to another sensory form that is more useful or available to a user having a particular disability or impairment.

Without limitation, the use of “coupon code/artifact” in this application refers to either single or multi-modal data capture.

### Virtual Coupon Creation and Use—Basic Overview

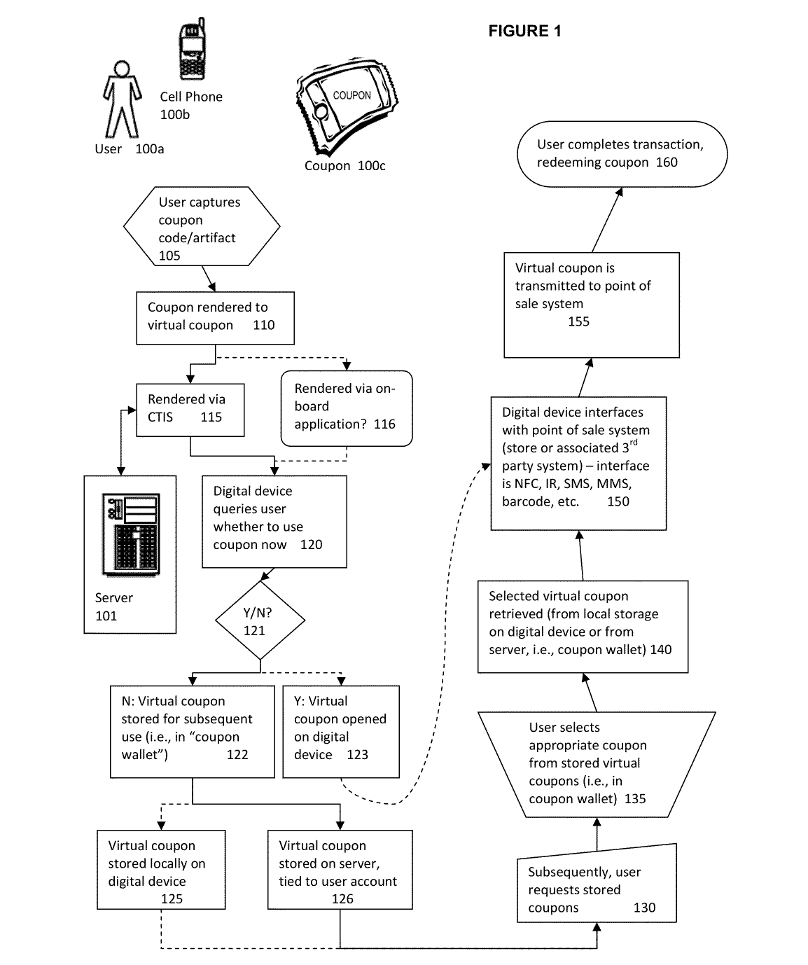

FIG. 1 shows a combined logic and data flow block diagram illustrating a general overview of the creation and use of a virtual coupon, in one embodiment. The system/method may be configured so that a user (100a) may scan a digital code (105) with a scanning device (100b), as for example by using a cell phone camera to scan and/or take a picture of a barcode, 2D code, matrix code, data matrix, QR code, or other such symbology present on a physical coupon (100c). In some embodiments, the “scan” may also be a multi-modal coupon code/artifact. An example of a mobile device and software capable of such code capture is the Nokia 6600 cellular telephone equipped with ConnexTo software. In other embodiments, the capture device (100b) may be capable of scanning codes associated with multimodal codes or artifacts, such as RFID tags, NFC tags, and/or the like. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “code scanning,” “artifact scanning,” “coupon code scanning,” “coupon code/artifact scanning,” or “coupon artifact scanning.” Once the user captures the coupon code/artifact (105), the coupon code/artifact is rendered to a virtual coupon (110) (the rendering process is further described below, see FIG. 2). This rendering can either be via a CTIS or server (115) or an on-board application (116). Once the virtual coupon is rendered, the digital device queries the user whether to use the virtual coupon now (120). After a yes or no response from the user (121), the virtual coupon is either immediately opened on the digital device (123) or stored for subsequent use (122), such as in local storage on the digital device (125) or in a server-based, digital “coupon wallet” (126). Mobile web payments and wallets may use direct operator billing, credit card, eWallets, SmartWallet, or online wallets. eWallet or “digital wallet” is also increasingly being used to describe mobile phones, especially smartphones, which store an individual's credentials and utilize wireless technologies such as near field communication (NFC) to carry out financial transactions or to store digital coupons or discount codes. Online wallets may include PayPal, Amazon Payments, eBay, Google Wallet, and Google Checkout. NFC employs a special mobile phone equipped with a smartcard that is waved near a reader module. Most transactions do not require authentication, but some require authentication using PIN, before transaction is completed. The payment could be deducted from a pre-paid account or charged to a digital wallet or bank account directly. NFC may be employed by Google Wallet, Visa DPS, and the like.

Upon a subsequent request from the user to retrieve stored coupons (130), the user selects the appropriate coupon from all stored/saved virtual coupons (135), either in local storage or in the “coupon wallet.” Once selected, the appropriate virtual coupon is retrieved from its storage location (local storage or the coupon wallet) (140). The digital device is then capable of interfacing with a purchase system (150), such as to conduct a transaction with a merchant. Without loss of generality, the method of interfacing can be near field communication (NFC), infrared (IR), short message service (SMS), multimedia messaging service (MMS), barcode scanning, and/or the like. Additionally, the purchase system may either be that of a merchant or a 3^{rd} party system associated with the merchant. The virtual coupon is transmitted/communicated through the interface method to the purchase system (155), and the user completes the transaction with the merchant (160), purchasing a product/service/good/item with the use of the virtual coupon.

### MMS

In one implementation, the Scan Message and/or scanned coupon code/artifact may be sent to the server (101) by a Multimedia Messaging Service (MMS) protocol. In other implementations, a wide variety of other communication protocols may be employed, including but not limited to: Short Messaging Service (SMS), instant messaging, web browser based messaging, email, Enhanced Messaging System (EMS), TCP/IP, WAP, and/or the like.

### Short Code

In one implementation, the server (101) may be addressed by a short code, short numbers, Common Short Code (CSC), and/or the like for sending the Scan Message and/or scanned coupon code/artifact. For example, a short code may appear alongside a coupon code/artifact on a printed coupon, and a user may be informed that the scanned coupon code/artifact should be sent to the indicated short code number in order to retrieve a Reply Message, virtual coupon, and/or the like. In other implementations, other addressing means may be employed, such as an ordinary telephone number, an email address, a universal resource locater (URL), and/or the like. In another implementation, the short code and/or other server address may be encoded within part of the coupon code/artifact itself. When the user scans the coupon code/artifact with his or her mobile device, the coupon code/artifact may be partially decoded by the client device to extract the address and automatically send the rest of the coupon code/artifact thereto.

Virtual Coupon Rendering with Code Triggered Information Server—Basic Overview

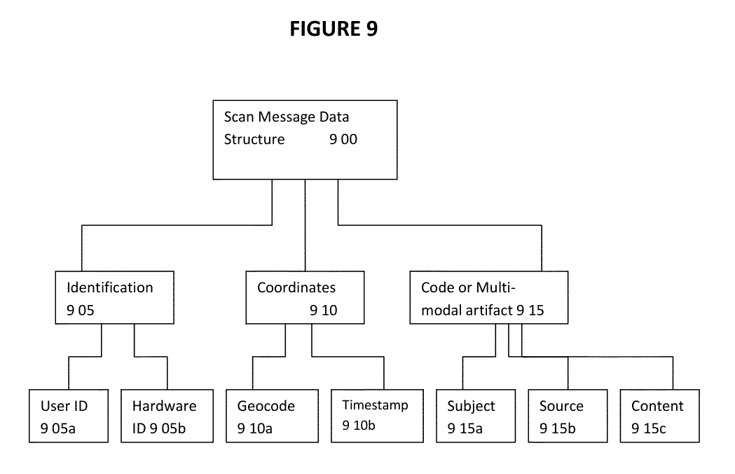

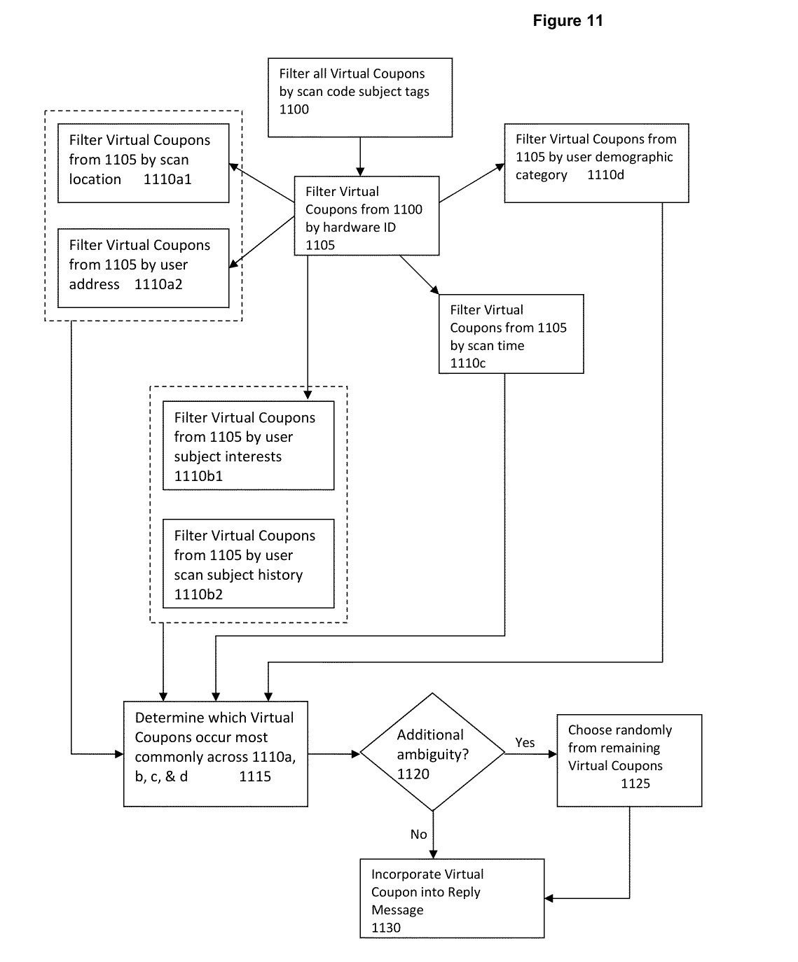

FIG. 2 shows a combined logic and data flow block diagram illustrating a general overview of the CTIS rendering a virtual coupon from a physical one, in one embodiment. The CTIS may be configured so that a user (200a) may scan a coupon code/artifact (205) with a scanning device (200b), as for example by using a cell phone camera to scan and/or take a picture of a barcode, 2D code, matrix code, data matrix, QR code, or other such symbology present on a physical coupon (200c). In some embodiments, the “scan” may also be a multi-modal coupon code/artifact. An example of a mobile device and software capable of such code capture is the Nokia 6600 cellular telephone equipped with ConnexTo software. In other embodiments, the capture device (200b) may be capable of scanning codes associated with multimodal codes or artifacts, such as RFID tags, NFC tags, and/or the like. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “code scanning,” “artifact scanning,” “coupon code scanning,” “coupon code/artifact scanning,” or “coupon artifact scanning.” The time and location (as determined by GPS, GPRS, or other such geo-positioning technologies) of the mobile device are determined (210), and a Scan Message (215) is generated containing a user identification (ID), a hardware ID that identifies the type of mobile device being used, a geocode (location of the device), a timestamp, and the scanned coupon code/artifact (see FIG. 9 and discussion of Scan Message below). Additional user-input information may also be supplied at this point. The Scan Message is packaged and sent (220) to a server (201) that receives and recognizes it (225). The user's profile, specific to the supplied user ID, is updated with the new Scan Message (i.e., it is added as a transaction to their profile transaction history) and queried (230) for information to use in the preparation of a Reply Message (240) that is also based on the content of the current Scan Message. The server selects (235) the virtual coupon content (see FIG. 11) of the Reply Message (245) from an Information Base and sends it to the user's mobile display device, which displays the pertinent content to the user (250). The Reply Message can be just a query to the user (i.e., whether or not to use virtual coupon now), a query plus the rendered virtual coupon, or just the rendered virtual coupon. If the Reply Message is just a query, then further user engagement with the CTIS is necessary to either deliver or store the virtual coupon (260).

Alternatively, the rendering of the scanned coupon code/artifact may be independent of the CTIS, through the use of a digital application on the digital device. In this embodiment, the digital device may either contain or independently access the user profile and/or virtual coupon information base in order to obtain the virtual coupon corresponding to the scanned coupon code/artifact.

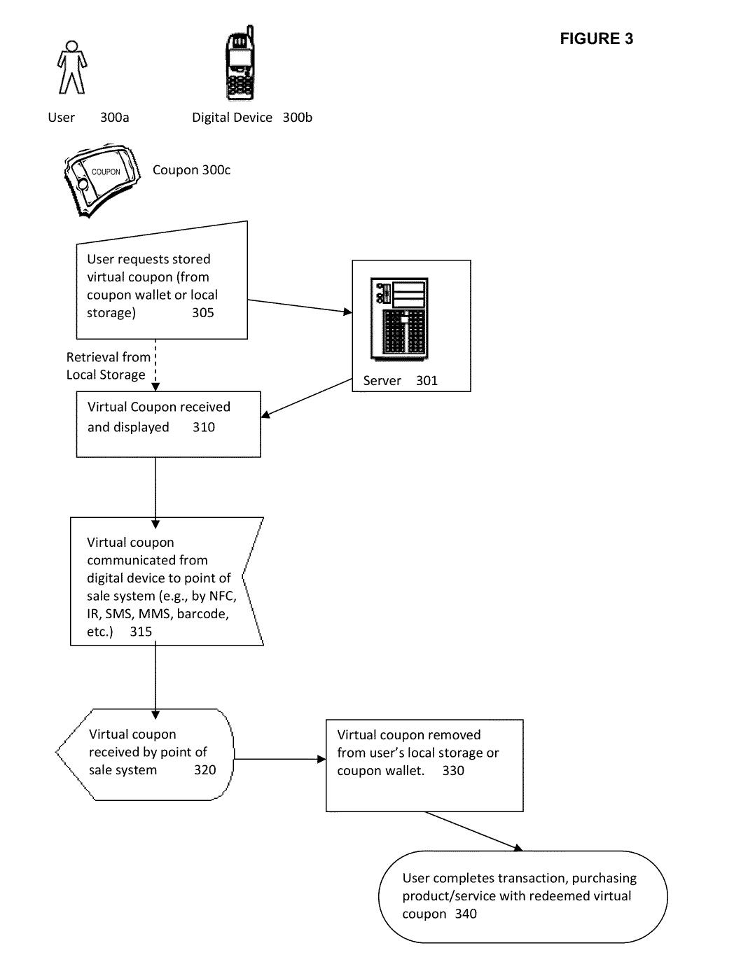

FIG. 3 shows a combined logic and data flow block diagram illustrating retrieval/delivery of a stored virtual coupon for redemption by a user at a point of sale. A user (300a) employs their digital device (300b) to request a stored virtual coupon (305). The virtual coupon will then be retrieved from the user's coupon wallet (on the server 301) and/or local storage on the digital device. The virtual coupon is then received and displayed on the digital device (310). The virtual coupon can then be communicated from the digital device to a purchase system (315), which purchase system can either be a merchant's system or a 3^{rd} party system associated with a merchant. The virtual coupon can be communicated by a variety of methods, including, without limitation, NFC, IR, SMS, MMS, barcode scanning, and/or the like. The virtual coupon is then received by the purchase system (320), and optionally removed from the user's coupon wallet and/or local storage on the digital device (330). The user may then complete the transaction with the merchant (340), purchasing a product/service/good/item with the use of the virtual coupon, which may satisfy any portion or all of the cost of the product/service/good/item.

### Scanning

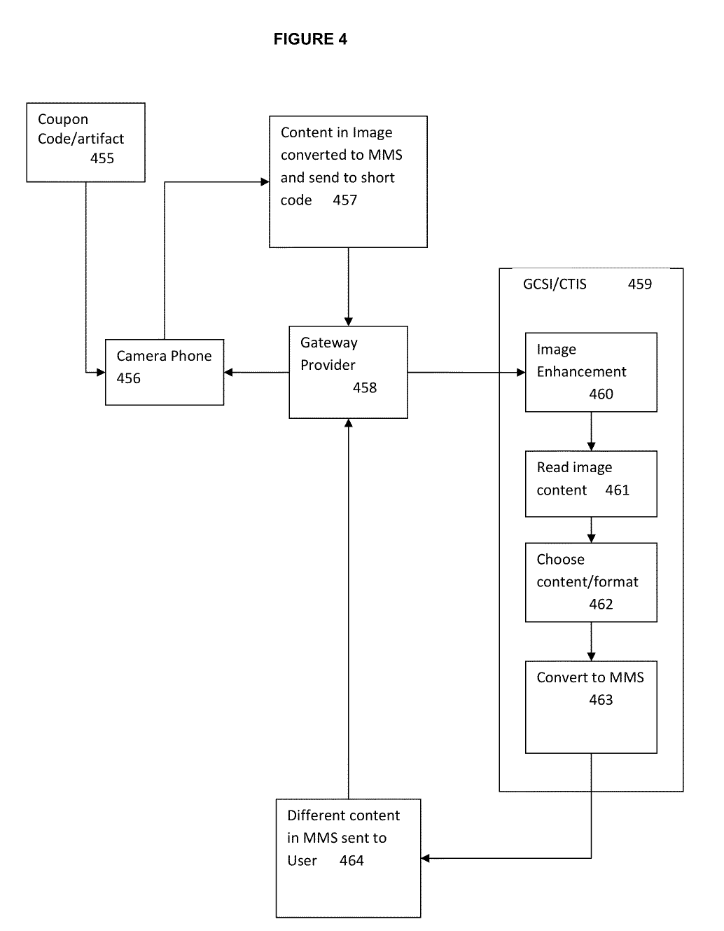

FIG. 4 shows an implementation of combined logic and data flow in another embodiment of virtual coupon operation. A coupon code/artifact (455) is scanned by a camera phone (456), and the resulting image content is converted to an MMS format to be sent via short code (457) through a gateway provider (458) to the CTIS (459) server. At the server, the image information may be enhanced, manipulated, and/or otherwise processed (460) so as to aid in determining the appropriate content to serve in response. After enhancement, the image content is read (461) and the content and format for the appropriate response is determined (462). A Reply Message is formed in MMS format (463) and is sent (464) back to a gateway provider (458) to be served to the user's camera phone (456).

In an alternative implementation, the scanned coupon code/artifact may be directly decoded on the client mobile device instead of on the server. The decoded content may then be converted to MMS format and sent via short code to the server in order to retrieve the appropriate virtual coupon content associated with the coupon code/artifact. That virtual coupon content may be returned from the server to the client mobile device by means of an MMS protocol as well.

### Virtual Coupon Creation

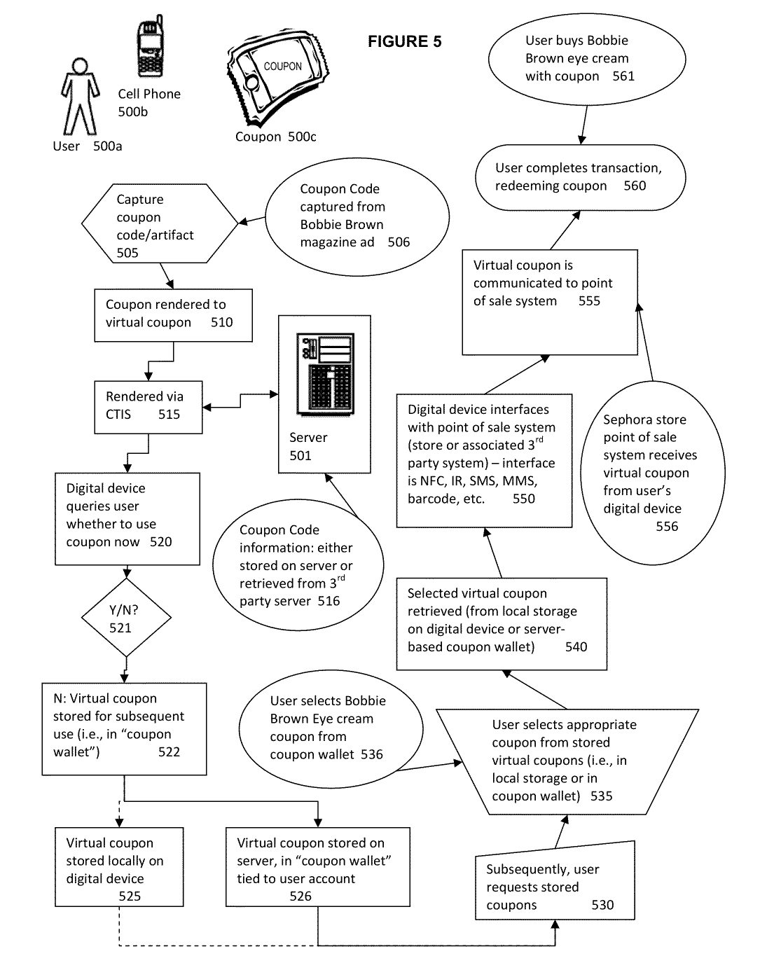

For illustration, the system/method of creating and using a virtual coupon is shown in FIG. 5 for a particular, exemplary embodiment: providing targeted and contextual information and virtual coupons to the user related to a cosmetics advertisement. Here, a user employs a cell phone to scan a coupon code/artifact associated with a Bobbie Brown eye cream advertisement in a magazine (506), such as by using the phone's built in camera to photograph a 2D matrix code (e.g., QR code). The location of the scan (San Francisco, Calif.) is determined by the phone's built in GPS receiver, and this location is incorporated as a geocode, along with the user ID, the hardware ID of the particular type of device (e.g., cell phone) used, the time, and the code content, into a Scan Message. This is sent to a server via the cell phone's data connection (e.g., wireless internet systems such as 1×EV-DO), and the server queries a database of user profiles based on the supplied user ID in order to update the appropriate user profile with the content of the current Scan Message and to determine what, if any, information in the user profile may be relevant to the preparation of the current Reply Message. In one embodiment, the user can supply a list of interests to be considered in addition to those culled from their scan history. The server selects the appropriate virtual coupon content to include in the Reply Message, comprised in this case of a virtual coupon for Bobbie Brown eye cream and/or a “use now” query. This reply is sent by the server to the user's mobile device which displays the appropriate virtual coupon and/or query content. The user can then store the virtual coupon in a “coupon wallet” associated with their user profile, or store the virtual coupon in local storage on the digital device. In this instance, the user goes to a Sephora store, which carries the Bobbie Brown eye cream, retrieves the virtual coupon (540), interfaces with the Sephora store purchase system (550), and transmits the coupon to the Sephora store purchase system (556). The user then obtains the Bobbie Brown eye cream through the use of the virtual coupon, created from a physical advertisement/coupon (561).

### Space-Time Trajectories—Reminders/Notifications

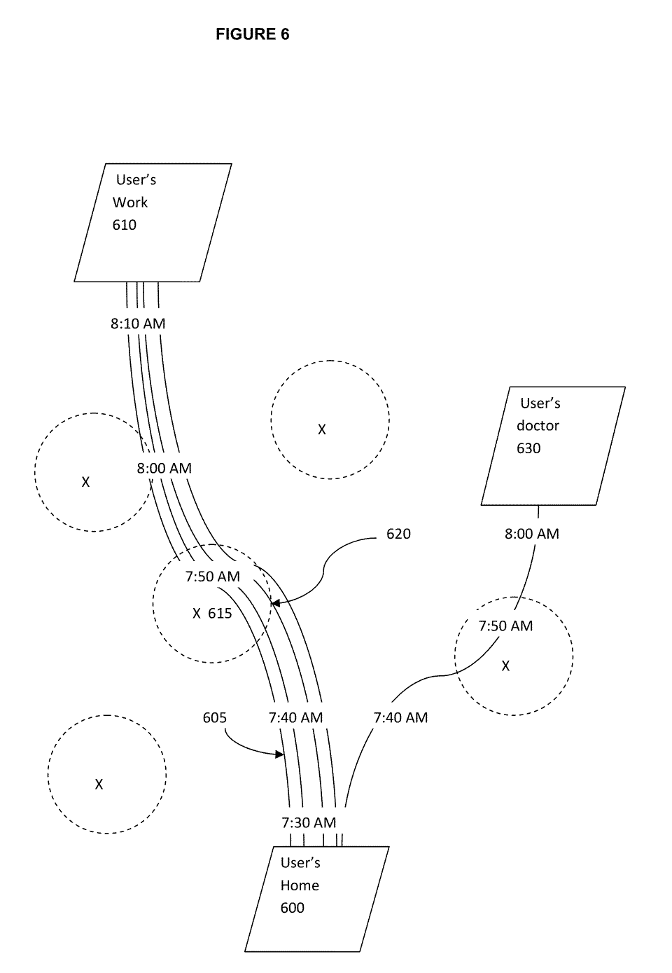

In one embodiment, the CTIS can serve information to the user based on the collected knowledge of user space-time trajectories contained in the user profile, without the need for any initiating user action. This embodiment is best illustrated by example, as drawn in FIG. 6. Here, a user rides a bus from home (600) to work (610) on four of the last five days, and takes a different bus to his doctor's office (630) on the remaining day. The space-time trajectories for the four work trips (605) and the one doctor trip (625) are determined by codes or coupons that the user scans with his cell phone from a newspaper during the bus rides or any general Global Positioning Tracking (GPS) system the user enables on the digital device. In this example, the user is assumed to scan a code or coupon every ten minutes starting at 7:30 AM until the destination is reached, and the geographic location of each scan is indicated by the position of the timestamp along each trajectory. In one embodiment, tracking occurs without scanning, simply by having the device send geocodes and timestamps by itself Along the way to his destinations, the user passes a number of virtual coupon providers (marked with X's) with virtual coupon content in the CTIS Information Base, with dotted circles indicating the locus of points that are a distance of two miles from each provider. One virtual coupon provider in particular (615), a gourmet coffee shop, is within two miles (620) of the user's space-time trajectory at 7:50 AM in four of the last five days. The user's coupon wallet contains an unused virtual coupon for this coffee shop. Consequently, on the sixth day, the server reminds the user of the virtual coupon for the coffee shop (615) at 7:45 AM. The user would then be able to engage in normal virtual coupon interaction.

In alternative embodiments, based on current geographic location, determined by recent coupon code/artifact scans and/or transmission of geocodes and timestamps by the digital device by itself, notifications could be sent to the user. An example of this situation would be where the user, with a GPS enabled digital device, is present in a store (which is connected with the CTIS). Based on recognition that the user is present in the store, for example a Best Buy store, the CTIS could independently analyze the contents of the user's coupon wallet and notify the user of any stored virtual coupons available for products or services potentially at Best Buy. Additionally, it is possible for the CTIS to analyze the user's profile as well as the contents of his/her coupon wallet, and notify the user of additional coupons that are similar to those in the coupon wallet (or determined to be relevant to the user based on his/her user profile, recent coupons scanned, ambient conditions, and the like). It is possible for marketer rules to exist that would monetize the system in these embodiments, such as by charging a fee to virtual coupon providers for the delivery of additional relevant coupons to users, due to the increased likelihood of user transactions with a merchant in response to the additional coupons.

### Code Triggered Information Server (CTIS) Detailed Overview

### User and Virtual Coupon Provider Participation

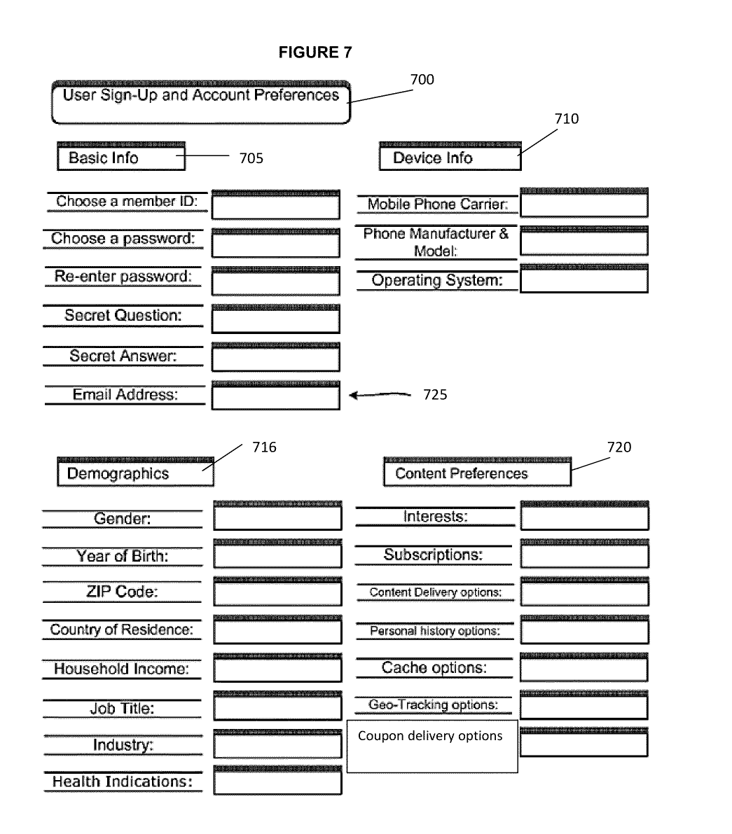

The CTIS may be enabled by the participation of virtual coupon providers and users. In one embodiment, virtual coupon providers supply virtual coupons for storage on the CTIS server. In an alternative embodiment, the virtual coupons are stored on third party servers that are referenced by the CTIS server. The user experience may be enhanced by the incorporation of personal preferences and demographic information to optimize the delivery and/or storage of virtual coupon content. Consequently, one embodiment would incorporate a user registration procedure. Users may register for the CTIS via the internet, telephone, postal mail, and/or the like. If a particular embodiment of the CTIS requires client software for the user to install, this could be supplied upon successful user registration. FIG. 7 shows an exemplary embodiment of a user registration interface 700, wherein a user can input Basic Info 705 (e.g., member ID, password, secret question/answer, e-mail address, etc.), Device Info 710 (e.g., mobile phone carrier, phone manufacturer & model, operating system, etc.), Demographics 715 (e.g., gender, year of birth, zip code, country of residence, household income, job title, industry, etc.), and Content Preferences 720 (e.g., interests, subscriptions, content delivery options, personal history options, cache options, geo-tracking options, virtual coupon delivery options, etc.) in a plurality of fields 725. In an alternative embodiment, a basic user identification packet (e.g., a “cookie”) is sent with a user's first code scan, thus establishing a basic user profile that can be filled in with greater detail at a later time.

### Code Capture (105)

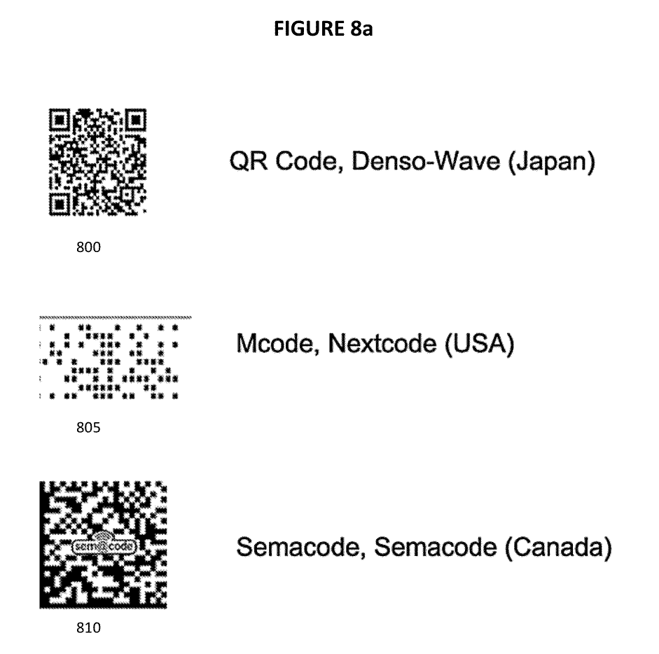

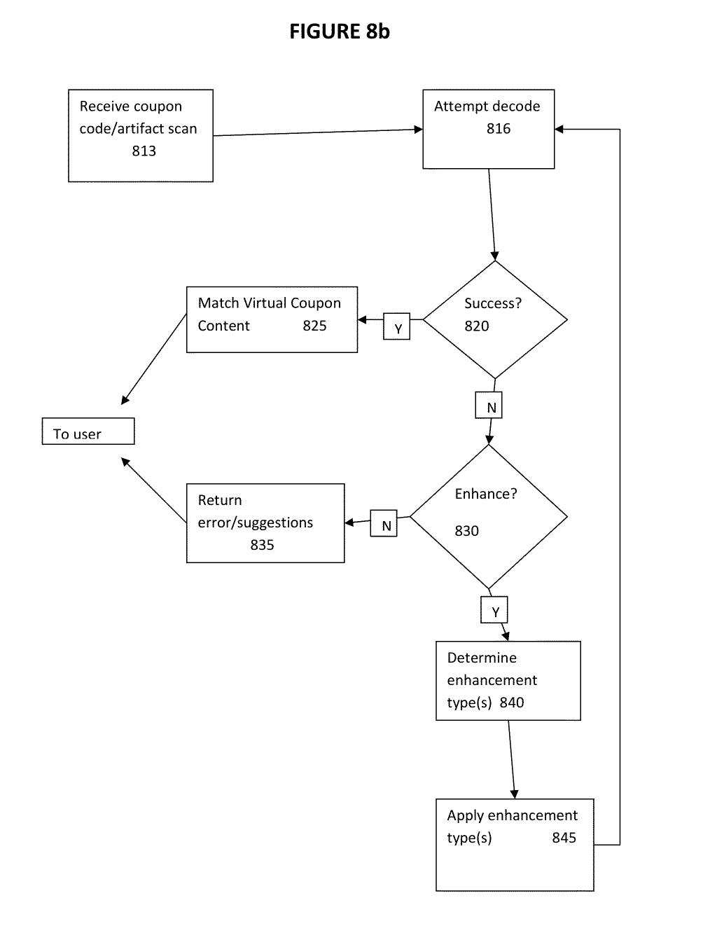

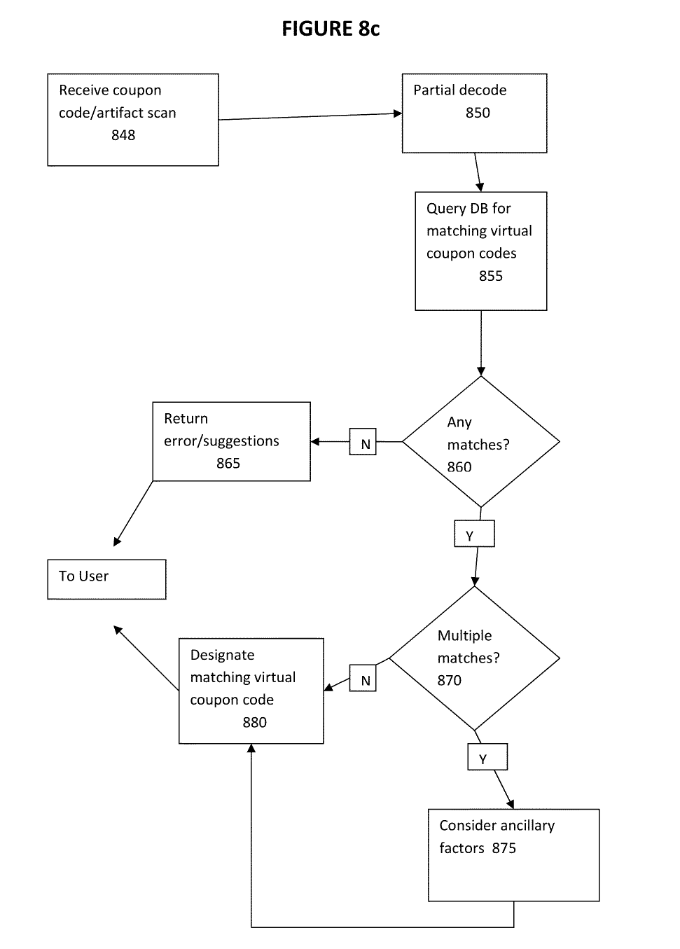

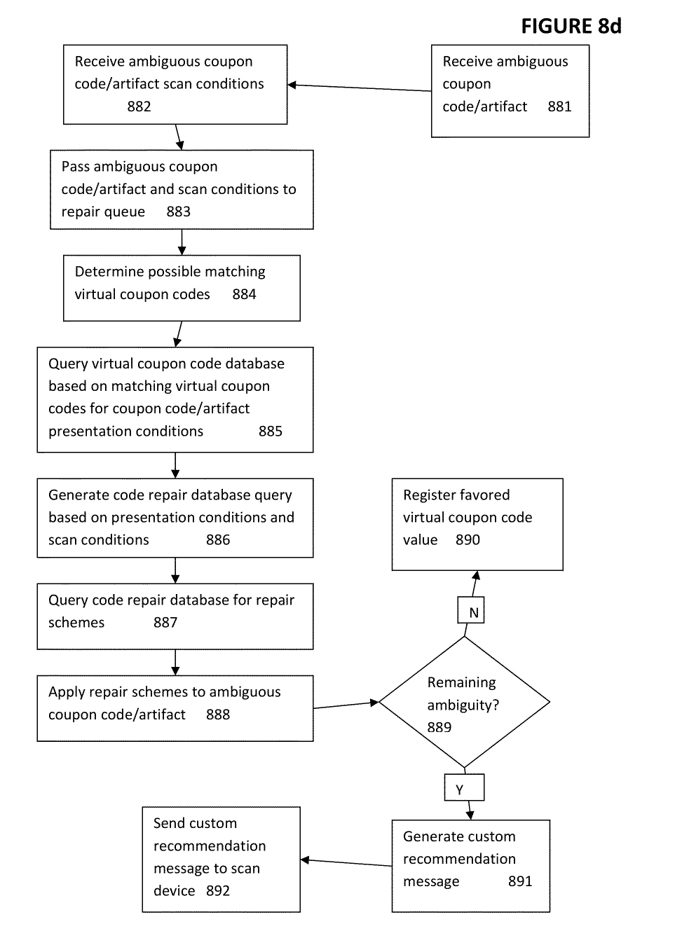

Scannable coupon codes/artifacts may be found in a variety of locations, including but not limited to newspaper and magazine articles/advertisements, signs and billboards, flyers, store locations and kiosks, consumer products, packages, clothing, stickers, printed coupons, websites, software displays, television broadcasts, virtual worlds, and/or the like. The nature of the coupon code/artifact and associated method with which the coupon code/artifact can be scanned will depend to some extent on where the coupon code/artifact is found, but among the possible types of coupon codes/artifacts are standard barcodes (e.g., UPC, EAN, Code 128, etc.), 2D matrix codes (e.g., QR code, Semacode, Data Glyphs, mCodes, etc.), user-input codes (e.g., text messages), RFID tags, NFC tags, pure images (e.g., an image of a printed coupon to be analyzed by optical character recognition), website links, software inputs, and/or the like. These codes may be located on any medium (e.g., on newspapers, magazines, books, printed coupons, video content, computer screens, embedded in objects (e.g., RFID tags on clothes, etc.), and/or the like). One embodiment employs 2D matrix codes, examples of which are provided in FIG. 8a, due to their large data capacity, ease of scanning, and resilience to damage or error. These examples include QR codes 800, Mcodes 805, Semacodes 810, and/or the like.

### Code Enhancement

In scanning a code, the code image may not always be recorded faithfully and/or in an ideal and/or suitable condition for decoding and/or matching to associated content. Consequently, the CTIS may be configured to enhance and/or otherwise process a code image in order to better recognize the code. FIGS. 8b-c show implementations of logic flow for processing and/or managing non-ideal code scans in embodiments of CTIS operation. In FIG. 8b, a scanned code is received at the CTIS server (813) and a first attempt is made to decode a received code scan (816). In one implementation, a received code scan may take the form of a bitmap image and/or a compressed bitmap image. If the decoding is successful (820), then the code is matched to associated content (825) that is ultimately destined to be served to a user. Otherwise, a determination is made as to whether enhancement should be applied to the scanned code (830). If not, then an error message and/or suggestions on how to improve the quality of the scanned code may be returned to the user (835). The CTIS may decide not to apply enhancement, for example, if enhancement has already been applied unsuccessfully to the same image before or if the quality of the image is so poor as to be clearly beyond improvement. If enhancement is to be applied, then the CTIS determines the appropriate enhancement type (840) based, for example, on the quality and character of the scanned code image and subsequently applies the enhancement (845), after which a new attempt is made to decode the scanned code.

In some implementations, multiple enhancement processes may be applied against a scanned code and the results compared in order to determine the encoded content. Prior to enhancement, the image may be downsized if necessary for speed of processing in applying multiple enhancements against the image. Image quality may also be increased if necessary in order to more successfully apply enhancements. For code images having extraneous information and/or noise, an enhancement process may be applied to remove all extraneous information, despeckle, and/or the like. For code images having shades of gray and/or shadows obscuring the encoded content, an enhancement process may be applied to manipulate the contrast and/or brightness of the image in order to create a pure black and white image for cleaner decoding. For code images that are tilted and/or not taken flat in a plane, an enhancement process may be applied to tilt the plane of the code to create a flat plane to aid in successful decoding. For code images that are rotated or skewed, an enhancement process may be applied to de-rotate, deskew, and/or otherwise recreate proper rectangular pixel groupings that can be decoded. For code images that are taken out of focus, an enhancement process may be applied to sharpen the image into recognizable pixel groupings. Additionally, the CTIS may apply edge recognition processes to the code image to create a set of potential code images that can be processed and compared to records in a code database.

### Partial Decoding

In some cases in which full decoding of a scanned coupon code/artifact image is impossible, a partial decoding may be accomplished and serving of content achieved on that basis. A partial decoding may, for example, result in a probabilistic virtual coupon code match without ever successfully decoding the complete coupon code/artifact. FIG. 8c shows an implementation of logic flow for partial decoding in one embodiment of CTIS operation. A scanned code image is received (848), partially decoded (850), and the partially decoded content used to query a code database to find matching codes (855). A determination is made if any matches exist (860) and, if not, then the CTIS may return an error message to the user and/or make suggestions about how to improve the image of the scanned code (865). If a match is found, however, then a determination is made as to whether there are multiple matches (870). If so, then the CTIS may consider ancillary factors (875) in attempting to isolate a single code as the most likely match to the received code. Such ancillary factors may include, but are not limited to: the incoming phone number, the carrier, the time of day, current code traffic, the source of the code, the context of the code, the user ID, the hardware ID, the user behavioral history, the user location, and/or the like. In considering ancillary factors, the CTIS is thus capable of predicting the true code based on knowledge of the user scanning the code, the context of the code, ambient factors, and/or the like. Once a unique code has been identified, this is designated as the matching code (880) and the CTIS proceeds with determining the appropriate associated content to serve to the user.

In an illustrative example of partial decoding, a given matrix code may encode the string ABC123. In multiple processes, it may be determined that the code contains A_{—}1_{—}3 (where the blanks represent unknown values), _C1_, and AB_. Through these multiple processes, the CTIS system now knows that the code contains ABC1_{—}3 and may check this against codes in a code database to determine how many matches exist. If it finds two matching codes (e.g., ABC123 and ABC143), it may consider ancillary factors. For example, ABC123 may correspond to a coupon for a ticket to a new action movie while ABC143 corresponds to a coupon for women's cosmetics. If the user supplying the code is determined, based on a supplied user ID, to be a man with a history of scanning movie-related coupon codes/artifacts, then the CTIS system may infer that ABC123 is the matching virtual coupon code and serve the corresponding content. In one implementation, the CTIS server may further supply a confirmation request for partially matched coupon codes/artifacts, requesting the user to affirm or deny that the supplied content is in fact the content that he or she was seeking

### Scan Message Data Structure (215)

The Scan Message generated by the CTIS is, itself, a novel data structure. In one embodiment that is illustrated in FIG. 9, it contains an identification field (905) comprising a unique user ID (905a) and a hardware ID (905b), both automatically supplied by the device used to scan and transmit the scanned coupon code/artifact; a coordinate field (910) comprising the location geocode (910a) (e.g., GPS coordinate, latitude and longitude, city and state, etc.) and timestamp (910b) of the scan; and a code field (915) supplying the specific content of the scanned code, which may include a subject code (915a) for the coupon code/artifact context, a source code (915b) indicating where the coupon code/artifact was located, and a content code (915c) indicating the specific information, if any, to be supplied in response to a scan of that coupon code/artifact.

In one embodiment, the XML for the Scan Message takes the following form:

<Scan_Message>
<ID>
<User ID> 012345 </User ID>
<Hardware ID> Nokia 660 </Hardware ID>
</ID>
<Coordinates>
<Geocode> GPS 40 46.516 -73 57.98 </Geocode>
<Timestamp> 08/21/2006 13:45:28 </Timestamp>
</Coordinates>
<Code>
<Subject> entertainment; movies; comedy </Subject>
<Source> New York Times </Source>
<Content> Coupon for discount on movie ticket </Content>
</Code>
</Scan_Message>

### Data Transmission (220, 225, 245, 250)

In one embodiment, sending and receiving the Scan Message and Reply Message will employ standard data transmission techniques to ensure successful transmission and to preserve data integrity (e.g., TCP/IP, 1×EV-DO, etc.). This is relevant for the Scan Message, which will contain the coded information scanned by the user. Such techniques may include but are not limited to the use of standard transmission protocols, “handshaking,” data compression, data encryption, and error correction.

### User Profile Structure (230)

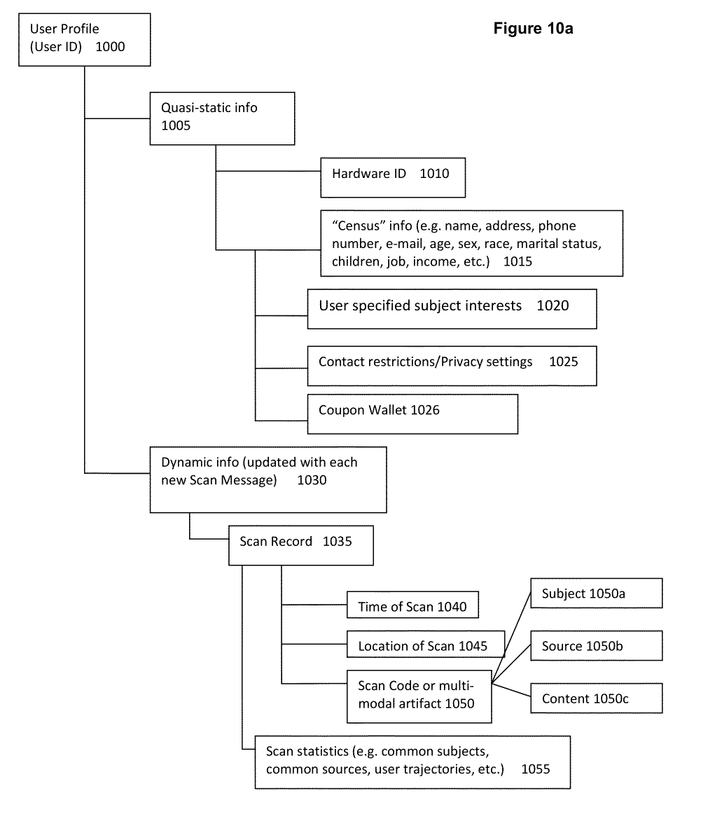

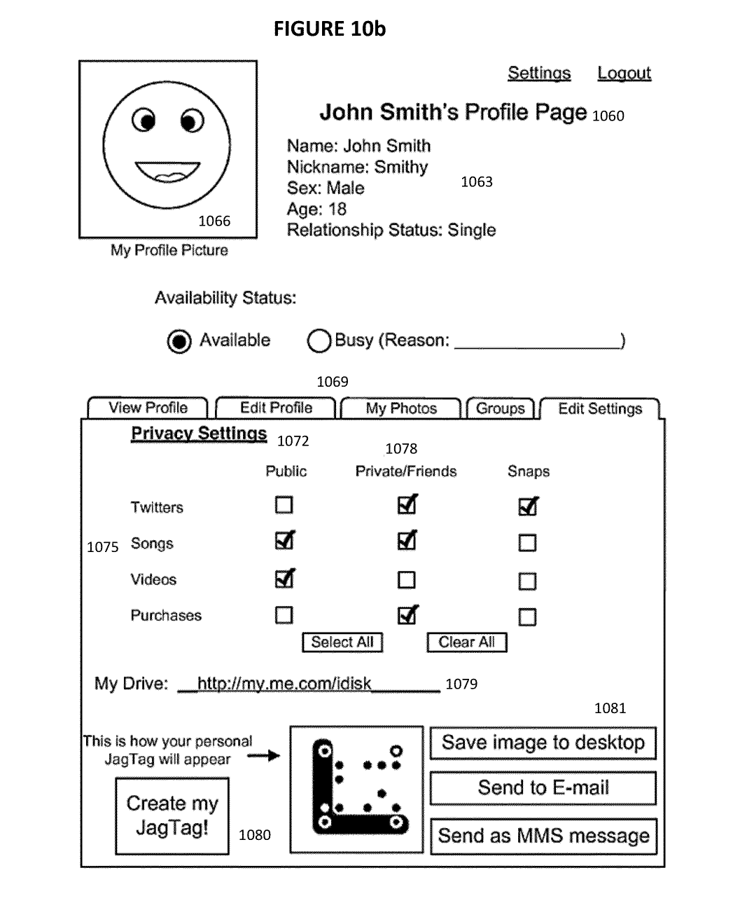

The content of the user profile generated by the CTIS is itself a novel data structure. In one embodiment illustrated in FIG. 10a, the profile (1000), which is uniquely specified by the user ID, will contain a category of quasi-static user information (1005) that is generally fixed over time and one of dynamic user information (1030) that is updated with each successive Scan Message that the user submits. The quasi-static info (the “quasi” qualifier indicates that this information may be updated, for example if a user changes their mobile device, however it does not change with each successive code scan) may include a hardware ID (1010); “census” info (1015) such as name, address, phone number, e-mail address, age, sex, race, marital status, number and age of children, job title, annual income, etc.; subjects of interest specified by the user (1020); and information regarding allowed methods to contact the user (1025), and information about the contents of the user's coupon wallet (1026). In one embodiment, this information could be supplied by the user when registering for the CTIS service as, for example, on a website. The dynamic info in the profile may include a scan record (1035), comprising the time (1040), location (1045), and scan code (1050) (including subject (1050a), source (1050b) and content (1050c)); and statistics related to the scan history (1055). Such statistics may include but are not limited to the most popular scan subjects, most popular scan sources, user space-time trajectories, etc. In one embodiment, the profile contains a series of identifying codes distilled from the profile content (e.g., demographic category code based on census info, subject codes, source codes, etc.) that can be compared with similar codes in the Scan Message to determine the appropriate virtual coupon content to include in the Reply Message. In an alternative embodiment, the profile contains identifying keywords or “tags” based on the profile content that can be compared with similar tags in the Scan Message to determine the appropriate virtual coupon content to include in the Reply Message. In both cases, the identifying labels for the user profiles may be input by CTIS administrators or automatically generated by an appropriate computer algorithm such as stripping header labels from virtual coupon descriptions (e.g., for example, stripping the header tags from an HTML virtual coupon).

In one embodiment, the XML for the User Profile may take the following form:

<User>
<Quasi-static info>
<User_ID>123-45-6789</User_ID>
<Hardware ID> Nokia 660 </Hardware ID>
<Census info> John Smith; 123 Maple Dr., Smalltown, CA 92676;
(123)456-7890; jsmith@email.com; 55 years; male; white; married;
2 children; etc.
</Census info>
<Interests> camping; fishing; classic cars; movies; etc. </Interests>
<Contact restrictions> Weekdays 8 AM - 7 PM only </Contact
restrictions>
</Quasi-static info>
<Dynamic info>
<Scan record>
<Scan_#1>
<Time> 08/21/2006 13:45:28 </Time>
<Geocode> GPS 40 46.516 -73 57.98 </Geocode>
<Code>
<Subject> entertainment; movies; comedy </Subject>
<Source> New York Times </Source>
<Content> Coupon for discount on movie ticket </Content>
</Code>
</Scan_#1>
<Scan_#2>
etc...
</Scan_#2>
etc...
</Scan record>
<Scan statistics>
<Popular subjects> entertainment; cars; travel; etc. </Popular subjects>
<Popular sources> New York Times; Car and Driver; CNN.com; etc.
</Popular sources>
<Trajectories> Data files listing time and geocode coordinates, computed
average trajectories, likely locations, etc. </Trajectories>
etc...
</Scan statistics>
</Dynamic info>
<Code>
<Subject> entertainment; movies; comedy </Subject>
<Source> New York Times </Source>
<Content> Coupon for discount on movie ticket </Content>
</Code>
</User>

In one embodiment, the user's contact restrictions/privacy settings (1025) may include an option to permit or deny detection of the user's current location. The location information, if permitted, could enable a user to receive notifications of available virtual coupons simply by entering a virtual coupon provider zone and/or a particular store. Additionally, the location setting could be utilized to notify the user of any virtual coupons in his/her coupon wallet that are valid at the user's current location (such as a store) and/or at nearby locations.

In one embodiment, data accumulated in a plurality of user profiles may be analyzed to extract information about codes that are scanned. For example, the frequency with which a particular code is scanned may be extracted from user profiles and parsed by geographic, temporal, and/or demographic criteria to yield code profiling information. This information may be stored in a code and/or virtual coupon profile. In an alternative embodiment, the virtual coupon profile may be constructed and/or updated by the CTIS immediately upon the receipt of a Scan Message rather than being extracted from user profiles.

### Information Base (235)

### Virtual Coupons and Labels—Searching

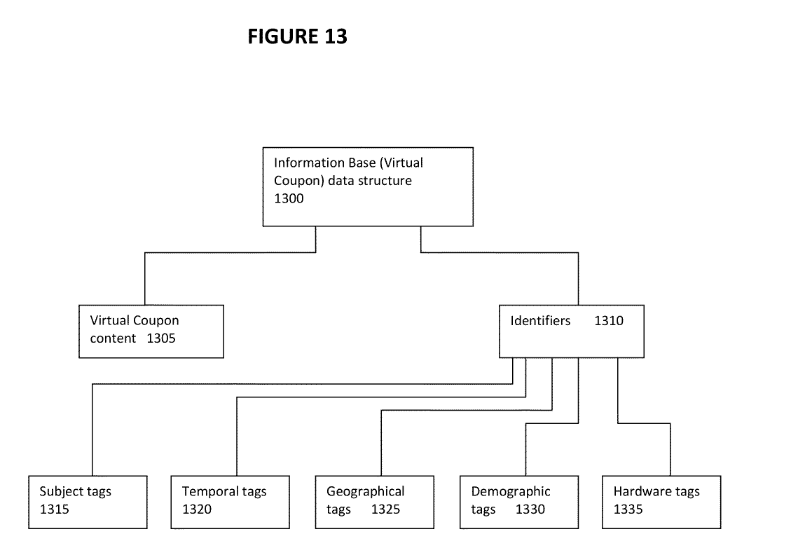

The Information Base contains the virtual coupon content that may be included in the Reply Message sent to the user and may be stored on the CTIS central server or on third party servers accessed by the CTIS. In one embodiment, each virtual coupon is associated with searchable labels. The virtual coupon content together with its labels, collectively referred to here as a virtual coupon, forms a novel data structure. In one embodiment illustrated in FIG. 13, the virtual coupon (1300) is comprised of the specific virtual coupon content (1305) (e.g., text, images, video, etc.) and a set of identifiers (1310) including subject tags (1315), information characterizing the temporal character of the virtual coupon based on which the virtual coupon may be triggered (1320) (e.g., 6 to 10 AM for a breakfast coupon), information characterizing the geographic specificity of the virtual coupon based on which the virtual coupon may be triggered (1325), demographic specificity of the virtual coupon (1330) (e.g., a virtual coupon for family vacations), and the hardware requirements of the virtual coupon (1335) (e.g., hardware IDs of devices capable of displaying the content of a particular virtual coupon). In one embodiment, the virtual coupon would also contain information identifying the source in which the virtual coupon code is to appear. In another embodiment, the virtual coupon would also contain code/virtual coupon profile data, describing the history and/or statistics of scans related to the virtual coupon.

In one embodiment, the XML for a virtual coupon may be in the following form:

< virtual coupon >
< virtual coupon_ID>123</ virtual coupon_ID>
< virtual coupon content>
Coupon for discount on R-rated comedy movie ticket
</ virtual coupon content>
<Identifiers>
<Subject> entertainment; movies; comedy </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> any (text only) </Hardware>
</Identifiers>
</ virtual coupon >

### Static Content and Dynamic Content in Reply

The CTIS queries the user profile to determine which Virtual Coupons to include from the Information Base in the Reply Message in order to tailor those Virtual Coupons to the user's profile characteristics, interests, and trajectories. In one embodiment, a scanned coupon code/artifact will yield two components in the Reply Message content: i) static content that is the same for every user who scans the coupon code/artifact, and ii) dynamic content that depends on the context of the user and the user profile. The static content (i) is determined from the scan coupon code/artifact, while the dynamic content (ii) is determined by a combination of the scan coupon code/artifact and the user profile, requiring a dynamic content generation heuristic to combine their respective influences. While a variety of such heuristic are possible and contemplated as being within the scope of this disclosure, and the specific heuristic employed in a given realization will likely depend on the precise application and intention, we discuss one embodiment of this heuristic here for illustrative purposes with reference to FIG. 11. In one embodiment, the scan coupon code/artifact and user profile is labeled with keywords or “tags” that identify the subject content of each. In an alternative embodiment, the scan coupon code/artifact, user profile, and Virtual Coupons are labeled with identifying codes. In either case, the heuristic exhibited in FIG. 11 first filters all Virtual Coupons in the Information Base by the subject code or tag of the scanned code (1100). The Virtual Coupons from 1100 are filtered by the hardware ID (1105) to ensure that the Virtual Coupon content can be successfully acquired and displayed by the user. The Virtual Coupons from 1105 are filtered into separate categories by scan location (1110a1), user address (1110a2), user specified subject interests (1110b1), user scan subject history (1110b2), scan time (1110c), or user demographic category (1110d). Virtual Coupons in each of these filtered categories are compared to determine which occur most commonly across 1110a, b, c, & d (1115). The server determines if 1115 has yielded a single Virtual Coupon (1120), and if so, it incorporates the Virtual Coupon's content into the Reply Message (1130). Otherwise, it chooses one Virtual Coupon at random from the remaining Virtual Coupons (1125) for incorporation. It must be emphasized again that this is but a single, specific embodiment of the user profile query heuristic intended for illustrative purposes. The heuristic is highly flexible and can be finely tuned for the specific application at hand. Some other possible methods may include alternative ordering of filters, addition or removal of filters, weighted filtering, complex conditional trees, and/or the like.

Alternatively, the dynamic content could indicate that a user is a member of a frequent shopper program and/or the like. This dynamic content could cause notification from the CTIS that virtual coupons are available to the user, which would not otherwise be available. In another embodiment, the dynamic content could permit rendering of a virtual coupon, because of a required demographic factor (such as membership in the frequent shopper program). The CTIS could also deliver virtual coupons that are more advantageous to the user than the physical coupon code/artifact scanned, based on the dynamic content (such as membership in the frequent shopper program).

### Heuristics—Filtering—Weighting

As an exemplary implementation of this embodiment of the Virtual Coupon filtering heuristic, we consider the situation discussed above with reference to FIG. 5. Here, the user scans a coupon code/artifact from an advertisement for Bobbie Brown eye cream in a magazine. Keywords associated with this code may include Beauty, Bobbie Brown, eye cream, makeup, etc. Consequently, only those Virtual Coupons possessing these identifying keywords are passed at 1100. In an alternative embodiment, the keywords may be ranked in order or relevance and the Virtual Coupons filtered accordingly. The Virtual Coupons from 1100 are filtered by Hardware ID; we presently assume that the user's mobile device is equipped with advanced capabilities (text, image, audio, video, internet, etc.), so that all Virtual Coupons are passed at 1105. In an alternative embodiment, the Virtual Coupon filter may preferentially choose those Virtual Coupons that take fullest advantage of the user device's display capabilities. Of the remaining Virtual Coupons, there is one virtual coupon redeemable on Bobbie Brown products (in addition to the eye cream coupon already scanned by the user) at Sephora that is tagged with a location code corresponding to the user's address, the user's specified subject interests (beauty, Bobbie Brown), and a portion of the user's demographic profile. The three tag matches (location, subject, and demographic) distinguish this Virtual Coupon from the others in the Information Base, which, in this example, all have two or fewer tag matches; so this unique Virtual Coupon, for Bobbie Brown products at Sephora, is chosen to be served to the user's mobile device. This targeted delivery of additional related coupons, such as by relying on the user profile, may be valuable to virtual coupon providers, and may be a service provided on a fee basis to virtual coupon providers.

### Relevance Rating

In one embodiment, the user may respond to a recommended virtual coupon with a relevance rating. This rating may then be stored in the user profile and/or employed to refine the criteria for tailoring future Virtual Coupons to that user.

In one embodiment, the Virtual Coupons would not be filtered by hardware ID at 1105. Rather, when a final Virtual Coupon has been selected for inclusion in the Reply Message following filtration under the other relevant criteria, the server will determine whether that Virtual Coupon is properly formatted for the device specified by the hardware ID. If so, then the Virtual Coupons will be included in the Reply Message as is. Otherwise, it will be converted into the required format appropriate to the user's mobile device. For example, if the selected Virtual Coupon contains color images but the server determines that the user's hardware device is an early model BlackBerry that only accommodates monochromatic text, the server will implement a peripheral application to strip the text content from the Virtual Coupon and incorporate only that in the Reply Message.

Additionally, the filtering could apply the hardware ID to restrict delivery of virtual coupons that would not be redeemable with the user's digital device. For example, if a virtual coupon, as designated by a virtual coupon provider, required redemption via NFC means, then the virtual coupon could only be delivered to digital devices capable of NFC functionality. It is possible for the virtual coupon to still be stored in the user's coupon wallet, for possible redemption using a different digital device (different cellular phone, tablet, etc.).

### Non-Triggered Virtual Coupon Serving

Though Virtual Coupons served by the CTIS are determined by coupon codes/artifacts scanned at some time in the past, it is possible for the CTIS to serve Virtual Coupons without any immediately contiguous, causal coupon code/artifact scan. A general illustration of virtual coupon reminder capability based on the user's coupon wallet was given above in FIG. 6, where each Virtual Coupon provider has specific geographic locations of operation. These are assumed to be stores/restaurants for the present purposes of illustration in this disclosure, but they may have different character for different embodiments and applications, including but not limited to kiosks, signs and billboards, offices, hospitals, real estate, shelters, emergency service providers, traffic monitors, individuals, websites, virtual world locations, and/or the like. A chosen distance surrounding each Virtual Coupon provider location defines a “provider zone,” where the metric by which “distance” is gauged may be generalized in the case of cyberspace/virtual world locations. A provider zone breach occurs when a user scans a coupon code/artifact within a provider zone. This may be regardless of the content of the scanned coupon code/artifact, for in this example the goal is to record the user's space-time position. In an alternative embodiment, a provider zone breach can be registered even if a user does not scan a coupon code/artifact within the provider zone, if the CTIS can infer a breach from two or more coupon code/artifact scans outside the provider zone through interpolation. When such a provider zone breach occurs, a special note may be incorporated into the user profile, such as in the Scan statistics module (1055), indicating the time and the particular Virtual Coupon provider.

In an alternative implementation, the CTIS may be configured to automatically query a user position without scanned coupon codes/artifacts. For example, a user's mobile device may be configured to periodically register its GPS location with the CTIS system. In another implementation, the CTIS may be able to continuously monitor the position of a client mobile device based on the cell site or tower to which the device is communicatively coupled. Cell site based user location may also be registered when a user scans a coupon code/artifact.

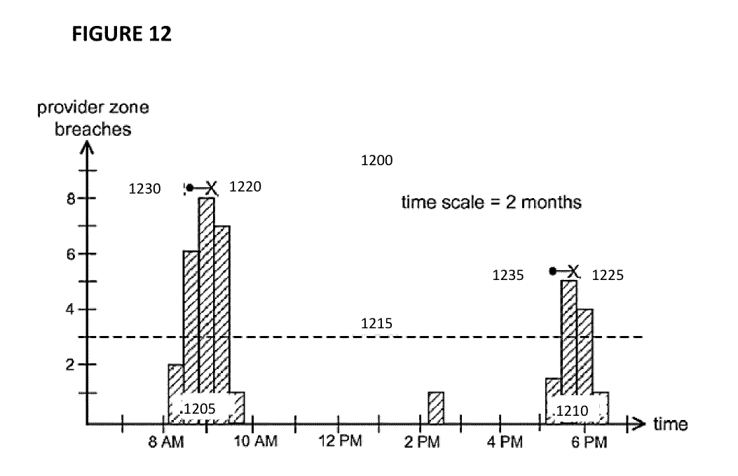

From an accumulated record of these breaches, data of the form of FIG. 12 can be determined. FIG. 12 shows a histogram (1200) of provider zone breaches in 20 minute intervals for a particular user over a chosen time scale, which we will take to be two months in this example. In one embodiment, such histograms will correspond to breaches of specific Virtual Coupon provider locations; while in an alternative embodiment, they will correspond to breaches of any of a plurality of locations corresponding to a specific Virtual Coupon provider; while in still another embodiment, they will correspond to breaches of different locations of related but different Virtual Coupon providers, chosen to target a specific collective user demographic. In this exemplary histogram, the significant provider zone breaches (those exceeding the threshold) are clustered around two times: one approximately centered at 9 AM (1205), and the other at 6 PM (1210). This may represent, for example, a user scanning coupon codes/artifacts as he passes the same Virtual Coupon provider location while riding a bus to and from work. In one embodiment, a threshold breach level (1215), indicated in FIG. 12 by a horizontal dotted line, is specified such that all breaches below this threshold number are ignored. This threshold level should be specified with respect to the time scale of the histogram; in the present example, the threshold is 3 breaches per two month period. The average peak times (1220, 1225) of the breach clusters that exceed this threshold are computed (marked by X's in FIG. 12), and a time is chosen prior to those averages (1230, 1235) to serve an appropriate Virtual Coupon to the user. In one embodiment, provider zone breaches could be sorted by scan subject, so that a histogram of the form of FIG. 12 could be constructed for a specific category of scans in order to further tailor the supplied Virtual Coupon content.

As a specific example of how this might work, we assume that the histogram (1200) of FIG. 12 represents provider zone breaches for a fast-food restaurant that a user passes on his way to and from work. A virtual coupon in the restaurant's base of provided virtual coupons matches the user's stated interest in gourmet coffee, and this virtual coupon is further labeled by a time identifier indicating that it is best served between 8 AM and 10 AM. Consequently, at 30 minutes before the user's average breach time of the provider's zone, the server supplies the virtual coupon to the user's mobile device, touting this restaurant's new line of gourmet coffee drinks Alternatively, the user's profile may specify that he is married with two children. This matches the demographic category of a virtual coupon in the provider's base which is also labeled by a time identifier indicating that it is best served between 5 PM and 8 PM. As a result, 30 minutes before the user breaches the provider's zone on his way home from work, the server notifies the user of the availability of the virtual coupon, touting a family-pack of hamburgers. The virtual coupon may automatically be added to the user's coupon wallet and/or delivered to the user's mobile device, or may require confirmation from the user prior to delivery/storage.

There are many methods of monetizing these non-triggered instances of virtual coupon service by the CTIS, especially through those embodiments employing user profiles. Marketing rules can be established for virtual coupon serving in embodiments of CTIS operation.

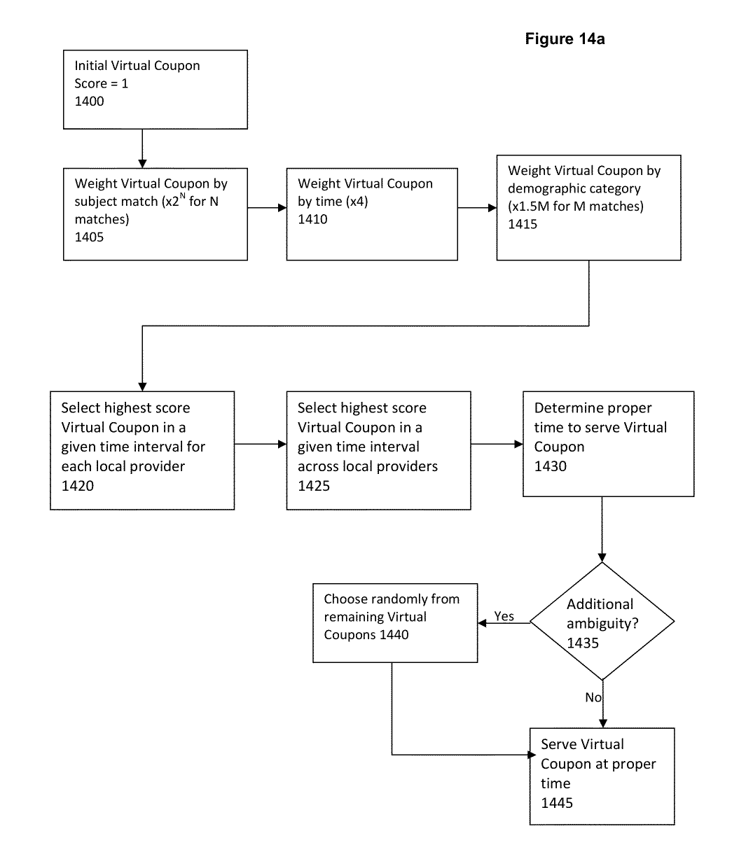

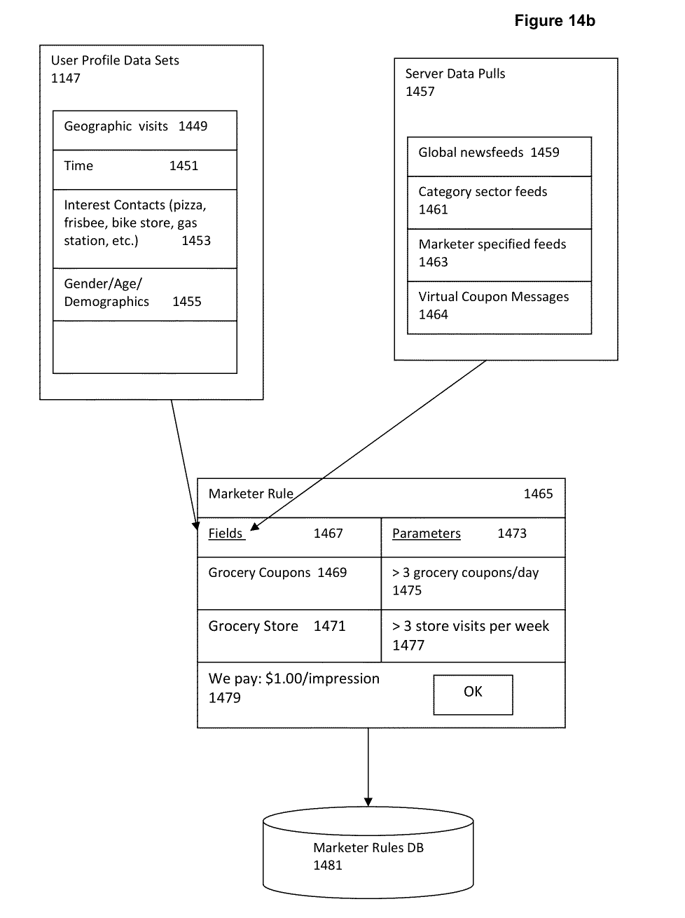

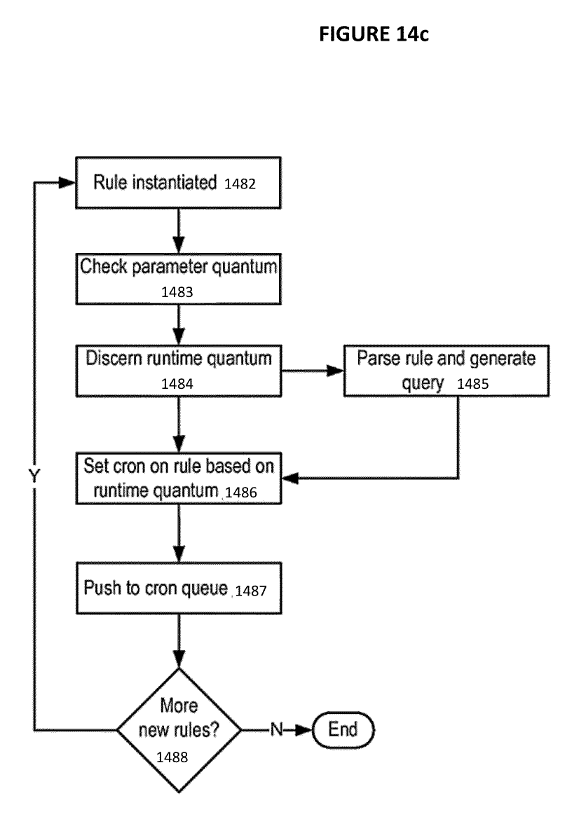

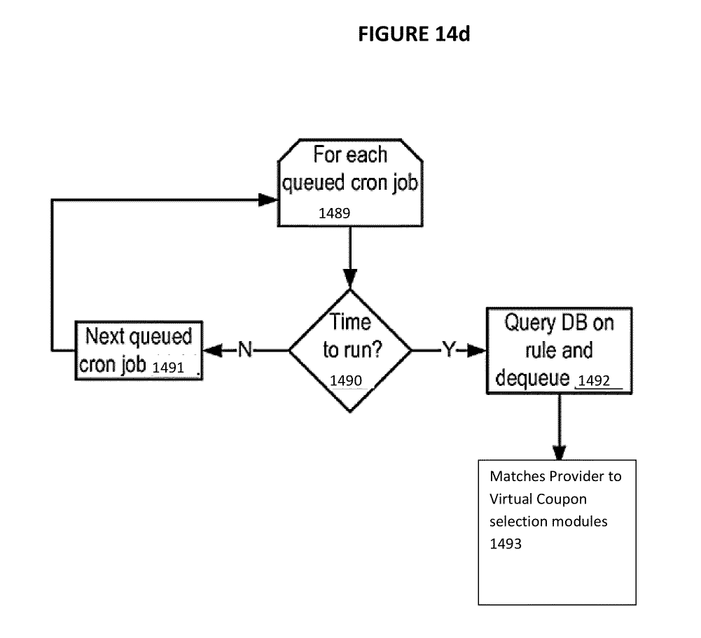

Selecting the proper Virtual Coupon to serve to the user in the non-triggered Virtual Coupon serving embodiment of the CTIS may be accomplished using a variety of heuristics that are best tailored to suit the specific use or application. Nevertheless, we present an example of a specific embodiment in FIG. 14a for illustrative purposes. In this embodiment, a weighting system may be employed to select among the Virtual Coupons of a specific Virtual Coupon provider once it is established that a Virtual Coupon from this provider is to be served to the user based on the analysis of FIG. 12. This weighting system begins by assigning a score of 1 (1400) to all Virtual Coupons in the Information Base corresponding to the provider. This score is multiplied by a subject coefficient (1405) for every match between the Virtual Coupon subject and the user specified subject interest or scan subject history. That coefficient is 2 in the present example, so N matches would yield a weighting factor of 2^{N}. The Virtual Coupon score may also be multiplied by a time coefficient (1410) if the serving time (1230 or 1235) falls within a time range specified for a particular Virtual Coupon. In the present example, the time coefficient is 4, expressing the greater importance of this factor compared to a single subject match. Finally, the Virtual Coupon score may be multiplied by a demographic coefficient (1415) for every match between the Virtual Coupon demographic category and that of the user. That coefficient is 1.5 in the present example, reflecting the diminished importance of this factor compared to the time and subject considerations. M demographic category matches will yield a weighting factor of 1.5^{M}. Once all of the Virtual Coupon provider's Virtual Coupons are scored in this fashion, those Virtual Coupons with the highest scores for that provider may be selected over the rest (1420). Similarly, the highest scoring Virtual Coupons from other providers are selected and the highest scoring Virtual Coupons over all providers can be selected to serve for a particular time interval (1425). Finally, the proper time to serve the Virtual Coupon (e.g., 30 minutes prior to the expected average provider zone breach time) is established (1430) and, if there is no further ambiguity (1435), the proper Virtual Coupon is served at that time (1445). Any residual ambiguity may be resolved by selecting randomly from the remaining Virtual Coupons (1440).

### Marketing Rules

In an alternative embodiment, the CTIS may be configured to receive and implement marketer rules for serving virtual coupons. FIG. 14b shows a schematic illustration of data structures related to establishment of a marketer rule for virtual coupon serving in one embodiment of CTIS operation. User profile data sets (1447) may include a variety of data fields related to user activities, interests, characteristics, and/or the like, such as but not limited to: geographic visits (1449), as may be recorded by coupon code/artifact scans; time (1451) associated with coupon code/artifact scans; interest contacts (1453), such as may reflect the user's interests and may be based on the context and/or associated content of scanned coupon codes/artifacts; gender, age, demographic, and/or other personal information (1455); and/or the like. Server data pulls (1457) may reference one or more data feeds to which the CTIS has access in order to draw information that may be pertinent to marketer rules and/or virtual coupon serving procedures. A wide variety of different types of feeds may be accessible, including but not limited to: global newsfeeds (1459), such as associated press wire services, weather information, sports scores, political and social events, financial market data, and/or the like; category sector feeds (1461), such as more specific and/or special interest news feeds; marketer specified feeds (1463); and/or the like. Additionally, there may be a virtual coupon messages feed (1464), which contains additional virtual coupon content that can be accessed and stored or delivered by the CTIS. This may include information about other virtual coupons present in the user's coupon wallet (or in local storage on the user's digital device). A marketer rule (1465) may be established by selecting one or more fields (1467) from the user profile data sets (1447) and/or the server data pulls (1457) and supplying associated parameters (1465) and/or parameter values associated with those fields. In the illustrated implementation, the rule associates a Grocery Coupon field (1469) with a parameter specifying more than three grocery coupons/artifacts scanned per day (1475). In addition, the rule associates a grocery store visitation field (1471) with a parameter specifying more than three visits per week (1477). If both of these conditions are deemed true for a given CTIS user, then the CTIS may serve one or more Virtual Coupons selected for and/or associated with the marketer rule. A price-per-impression (1479) may be charged for each time that the Virtual Coupon is served to a user under the circumstances specified by the rule. In one implementation, a marketer may propose a price-per-impression when he or she creates the rule, which is then submitted to the CTIS and/or a CTIS administrator for approval. In another implementation, the CTIS may automatically generate a price-per-impression based on the rule and/or the marketer. For example, a fixed charge may be applied for each additional field and associated parameter added to the rule, as this refines the specificity with which the associated Virtual Coupons will be served and increases the likelihood of transactional consummation. Once a rule is complete, it may be entered for storage and subsequent use in a marketer rules database (1481). It should be understood that the functionality described for this embodiment of the CTIS may be integrated or employed within any of the other CTIS embodiments described herein.

In one embodiment, the XML for the above marketer rule may take a form similar to the following:

<Rule>
<Rule_ID>123</Rule_ID>
<Rule_name> Grocery Rule </Rule_name>
<Rule_owner> Virtual Coupons R Us </Rule_owner>
<Condition1>
<Field1> Grocery Coupon </Field1>
<Parameter1> 3 or more grocery coupons/day </Parameter1>
</Condition1>
<Condition2>
<Field2> Grocery Store </Field2>
<Parameter2> 3 or more visits per week </Parameter2>
</Condition2>
< Virtual Coupon_database> Grocery Virtual Coupons
</ Virtual Coupon_database>
<Price>
<Amount> $1.00 </Amount>
<Contingency> Impression </Contingency>
</Price>
</Rule>

In one implementation, the elements of FIG. 14b may form the basis of a user interface for marketer rule generation. A marketer and/or other CTIS user may be presented with lists of user profile data sets (1447) and server data pulls (1457) that may be dragged and dropped to the marketer rule box (1465) to generate a marketer rule. When the parameter values have been specified and the rule is complete, the user may click OK to submit the rule and/or drag and drop the rule to a marketer rules database icon (1481).

FIG. 14c shows an implementation of logic flow for generating a rule queue in one embodiment of CTIS operation. A rule is instantiated (1482), and the CTIS server checks parameter quanta associated with the rule (1483). A runtime quantum is discerned for the rule (1484) to determine the timing for applying the rule. The rule is subsequently parsed to generate the appropriate query structure (1485), and the cron schedule for the rule is established based on the runtime quantum (1486). The rule may then be pushed to the cron schedule queue (1487), and a determination made as to whether there are any additional new rules to process (1488).

FIG. 14d shows an implementation of logic flow for cron job queue management in one embodiment of CTIS operation. The CTIS may monitor the cron job queue and, for each queued cron job associated with a rule that is next in the queue (1489), the CTIS may determine whether or not it is time for that particular cron job to run (1490). If not, then the CTIS passes to the next cron job in the queue (1491). On the other hand, if it is time to run, then the appropriate databases specified in the rule are queried, and the particular cron job is dequeued (1492). If the results of the database query match the rule criteria so as to require serving a virtual coupon impression to a user, then that match indication may be passed to Virtual Coupon selection modules in order to choose a virtual coupon to supply to the user. In one implementation, the marketer rule itself may uniquely determine a virtual coupon to serve. In another implementation, the marketer rule may determine a set or class of virtual coupons to serve, from which a unique virtual coupon may then be randomly selected. In yet another implementation, a virtual coupon may be selected from the marketer rule determined set or class of virtual coupons based on a user profile.

It must be emphasized again that this is but a single, specific embodiment of the non-triggered Virtual Coupon serving procedure intended for illustrative purposes. The procedure is highly flexible and can be finely tuned for the specific application at hand. Some other possible methods may include different relative weighting factors, alternative weighting considerations, categorical filtering, consideration of the number of provider zone breaches above the threshold level, graduated consideration of the distance from the provider location, modified provider zone shapes, pattern recognition algorithms, artificial intelligence facilitation, virtual coupons present in the user's coupon wallet (or in local storage on the user's digital device), and/or the like.

### Coupon and Content Sharing

In another embodiment, the CTIS provides targeted coupons to consumers. By scanning a coupon code/artifact in an article or advertisement of interest, a user may be provided with a virtual coupon for a store or establishment near the location where the scan took place, thereby increasing the likelihood that the coupon would be used. Choosing the virtual coupon based on the contents of the user profile may further increase the likelihood of a consummated transaction.

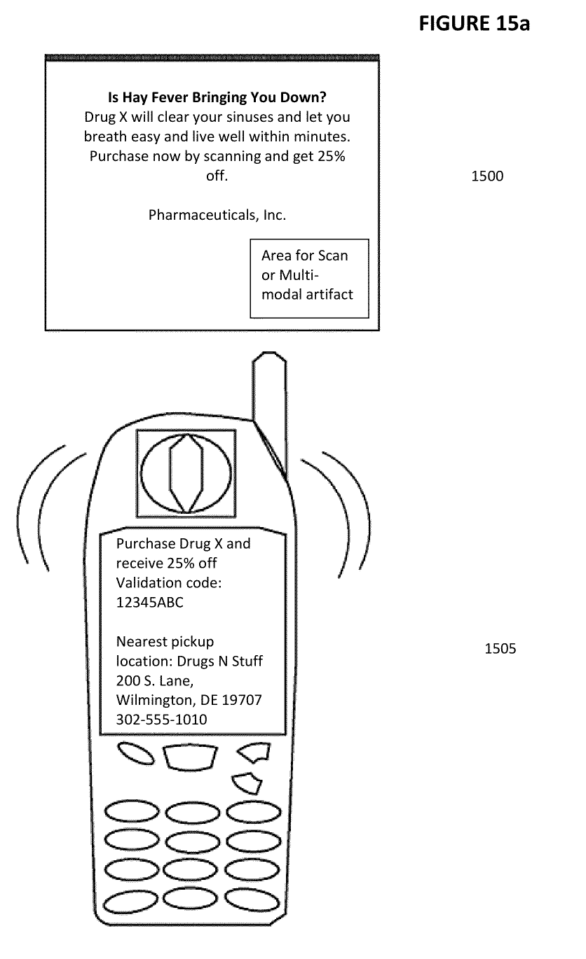

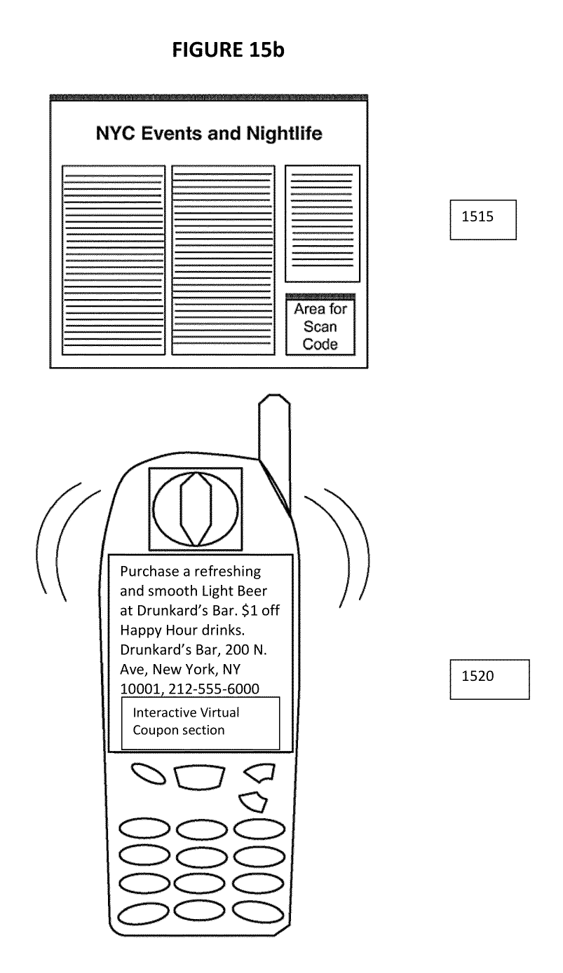

FIGS. 15a-b show two examples wherein the CTIS supplies coupons to a user. FIG. 15a shows a business card 1500 for a pharmaceutical salesperson that contains a scan coupon code/artifact. Upon scanning the coupon code/artifact, the user's cell phone is supplied with a virtual coupon 1505 for 25% off an associated medication from the salesperson, along with the store's location at which to redeem the virtual coupon. FIG. 15b shows an article related to events and nightlife in New York City 1515 that contains a scan coupon code/artifact. Upon scanning the coupon code/artifact to obtain additional content, the user may be provided with a virtual coupon for a local bar 1520, including a coupon off of happy hour prices based on the time of the scan.

### Code-Mediated Content Delivery Platform

Embodiments are directed to apparatuses, methods, and systems for a code-mediated virtual coupon delivery platform comprising a Graphical Code-Serving Interface and a Code Triggered Information Server (“GCSI/CTIS”). The GCSI/CTIS connects information encoding symbologies, and by proxy the underlying information content, to graphical display elements and facilitates generation of encoding symbologies, error-correction, media sampling and purchasing, social networking, and sales promotion programs.

In an embodiment, active display elements provide access to information, particularly information that is targeted to an individual's profile, interests, and/or contextual surroundings and that is portable and/or made available in unexpected physical locations. The active display elements facilitate the serving of such information via placement of information encoding symbologies, such as matrix codes, proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional information, multimedia content, offers, virtual coupons, notifications, and/or the like.

In one embodiment, a code sent via a communications network from a mobile communications device from a user is received. The code is based on a scan of an optically-readable coding symbol. A code database is queried to discern a multimedia content data identifier corresponding to the received code. Multimedia content data is retrieved from a multimedia database based on the multimedia content data identifier. A sample of the multimedia content data is sent to the mobile communications device via a communications network. A sample acceptability message is received from the user. The multimedia content data is sent to a data repository associated with the user provided that the sample acceptability message indicates that the user wishes to receive the multimedia content data.

In another embodiment, an alphanumeric string comprising a plurality of characters and representing a location of multimedia content data is received from a first data source. Each of the plurality of characters of the alphanumeric string is converted into a corresponding binary number to yield a plurality of binary numbers based on a character correspondence table. The plurality of binary numbers are concatenated to yield a bitwise array. An optically-readable encoding symbol comprising a plurality of disconnected solid shapes is drawn in which the presence of a solid shape at a position in the symbol indicates presence of a 1 in a corresponding position of the bitwise array.

In another embodiment, an incomplete code associated with an optically-readable encoding symbol is received. A code database is queried based on the incomplete code to determine a plurality of possible matching codes. The code records associated with the plurality of possible matching codes are queried to retrieve code presentation conditions associated with each of the plurality of possible matching codes. A plurality of code repair schemes are retrieved from a code repair database based on code presentation conditions. Each of the plurality of code repair schemes are applied to the incomplete code to yield a plurality of repaired codes. A repaired code is selected from the plurality of repaired codes based on at least one pre-designated code fidelity rule. The repaired code is designated as a correct code corresponding to the optically-readable encoding symbol.

In another embodiment, a scan indicator comprising an indication that a user has scanned an optically-readable encoding symbol with a mobile scanning device is received. The optically-readable encoding symbol is associated with a good or service. A retailer at which the user scanned the optically-readable encoding symbol is identified. A retailer record is queried to determine whether the retailer is subscribed to a sales promotion program. The retailer is charged a first retailer fee based on the received scan indicator if the retailer is subscribed.

In another embodiment, an online social network is provided. A user identifier is received and stored. User profile information is received and stored in association with the user identifier. A plurality of user scan indicators indicating that a user has scanned a plurality of optically-readable encoding symbols are received. The plurality of user scan indicators are stored in association with the user identifier. At least one friend designation indicating an association with at least one other user is received and stored in association with the user profile.

Users may scan codes found in media publications, on billboards or signs, on consumer products or packages, on websites or television screens, on movie screens, on clothing or accessories, on mobile device displays, and/or the like.

In an alternative implementation, content associated with a captured code or other user interest registration may be sent to a data repository other than a user's mobile device. For example, a user may scan a code corresponding to media content. Rather than triggering the GCSI/CTIS to send the media content to the mobile device with which the code was scanned, the code scan may trigger the GCSI/CTIS to send the media content to a user's computer, an online data repository, and/or the like for storage and later retrieval by the user. For example, the GCSI/CTIS may discern a user identity from the Scan Message (215), query user access and/or authorization information, and use that access and/or authorization information to access an online data repository corresponding to the user to store requested media content thereon for later retrieval and/or use by the user.

FIG. 8d shows an implementation of logic flow for customized repair and/or decoding of obscure or ambiguous scanned coupon codes/artifacts. An ambiguous code may be received at a GCSI/CTIS system at 881, such as may be sent via a communications network from a user's mobile scanning device. In one implementation, a scanned coupon code/artifact may be qualified as an ambiguous coupon code/artifact if an attempt to decode the coupon code/artifact does not yield a single result. In one implementation, the system may also receive coupon code/artifact scanning conditions 882 describing any of a variety of circumstances of the coupon code/artifact scan which may affect the quality and/or fidelity of the scanned coupon code/artifact. For example, some relevant circumstances may include the time of day, light levels, use of flash, mobile scanning device type and/or characteristics, coupon code/artifact size, contrast, brightness, sharpness, skew, rotation, and/or the like. The ambiguous coupon code/artifact and scan conditions may then be passed to a repair queue 883, whereby the system may analyze the ambiguous coupon code/artifact and attempt to discern the correct decoded virtual coupon content. A plurality of possible matching virtual coupon codes are determined at 884, and a virtual coupon code database is queried at 885 to extract coupon code/artifact presentation conditions corresponding to each of the plurality of matching virtual coupon codes. Coupon code/artifact presentation conditions may describe how and where the coupon code/artifact was displayed and may comprise a wide variety of factors, such as but not limited to medium (e.g., newspaper, glossy paper, product packaging, television display, website, billboard, and/or the like), likely obscuring factors (e.g., glass covering, tears, distance, and/or the like), and/or the like. The GCSI/CTIS system may then generate a code repair database query based on the presentation conditions and/or scan conditions 886 and query the repair database to extract repair schemes corresponding to the particular presentation and/or scan conditions. For example, a particular code repair scheme may be tailored for and/or correspond to coupon codes/artifacts displayed on billboards that are scanned after dark by Nokia mobile phones. Extracted repair schemes corresponding to each of the possible matching virtual coupon codes are applied to the ambiguous coupon code/artifact at 888, and a determination is made at 889 as to whether any one of the possible matches is now more likely to be correct than the others. This determination may be made, for example, by measuring the fidelity of coupon codes/artifacts with various repair schemes applied and selecting as the correct coupon code/artifact that which has the highest resulting fidelity. If no remaining ambiguity exists as to the correct coupon code/artifact, then the favored coupon code/artifact is registered with the GCSI/CTIS system at 892. Otherwise, the GCSI/CTIS may generate a custom recommendation message 890 and send the message to a user and/or a user's mobile device 891. The custom message may, for example, provide tailored recommendations on how the user may improve the fidelity of the coupon code/artifact scan based on the possible matching coupon codes/artifacts and the associated presentation conditions and/or scan conditions. Tailored recommendations, as well as the repair schemes themselves, may be adjusted based on feedback received from users about which coupon codes/artifacts they were actually trying to scan. In one implementation, the GCSI/CTIS may provide a query message to a user presenting a summary of content associated with alternative matching codes in order to determine which content the user was actually trying to access. It should be noted that code analysis and/or repair may be undertaken on a code image level, alphanumeric string level, binary string level, and/or the like basis. Combinations of such bases may also be undertaken, such as by first analyzing the ambiguous code in its alphanumeric string form and then, if ambiguity remains, analyzing the code in its binary form. Further discussion on such an analysis is provided below.

In an illustrative example of partial decoding, a given matrix code may encode the string ABC123. In multiple processes, it may be determined that the code contains A_{—}1_{—}3 (where the blanks represent unknown values), _C1_, and AB_.

Through these multiple processes, the GCSI/CTIS system now knows that the code contains ABC1_{—}3 and may check this against codes in a code database to determine how many matches exist. If it finds two matching codes (e.g., ABC123 and ABC143), it may consider ancillary factors, including code presentation and/or code scan conditions, user profile information, and/or the like. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the GCSI/CTIS system may infer that ABC123 is the matching code and serve the corresponding content. In one implementation, the GCSI/CTIS server may further supply a confirmation request for partially matched codes, requesting the user to affirm or deny that the supplied content is in fact the content that he or she was seeking.

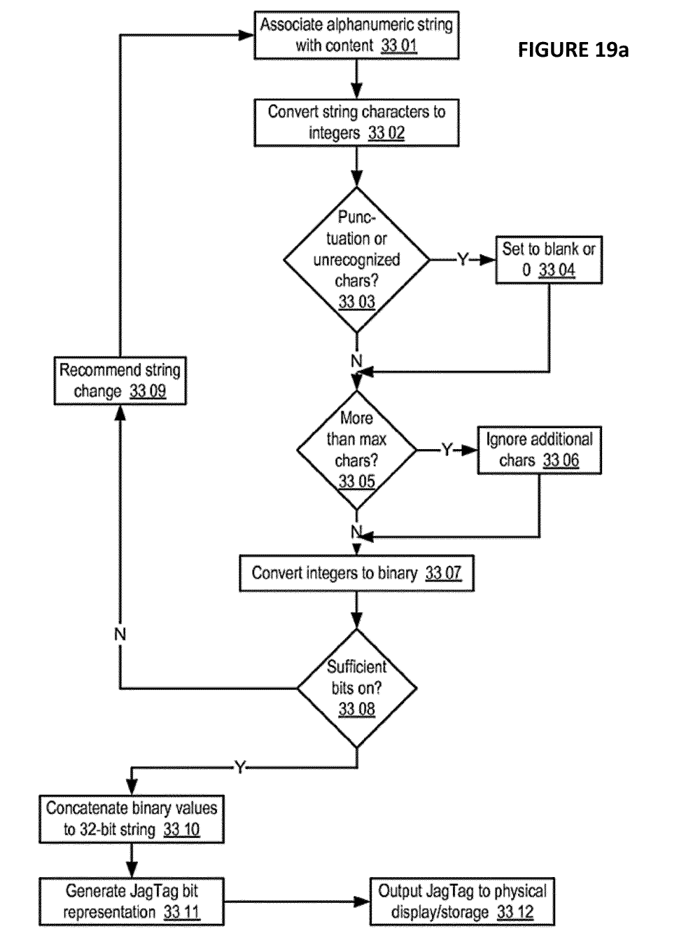

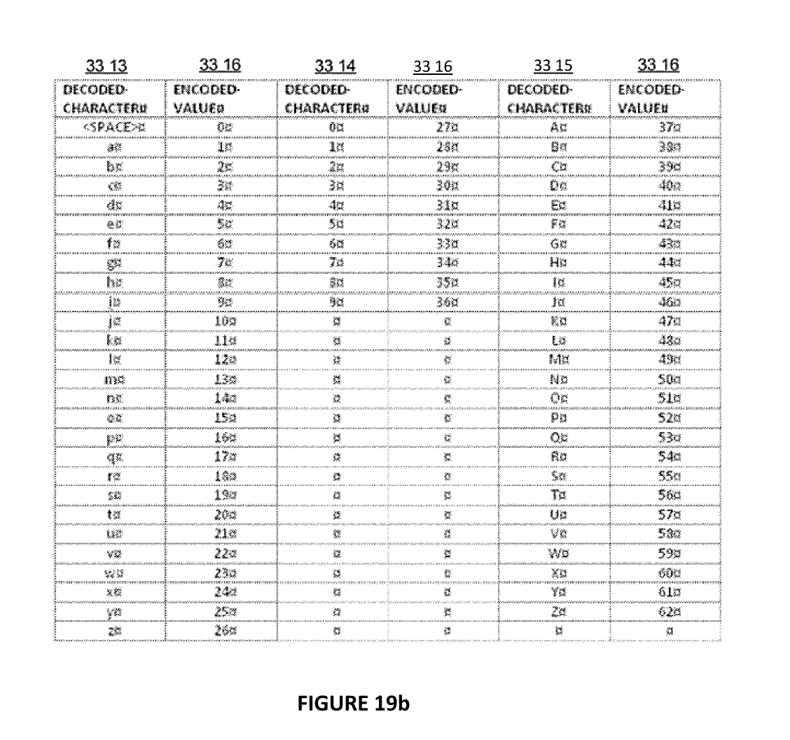

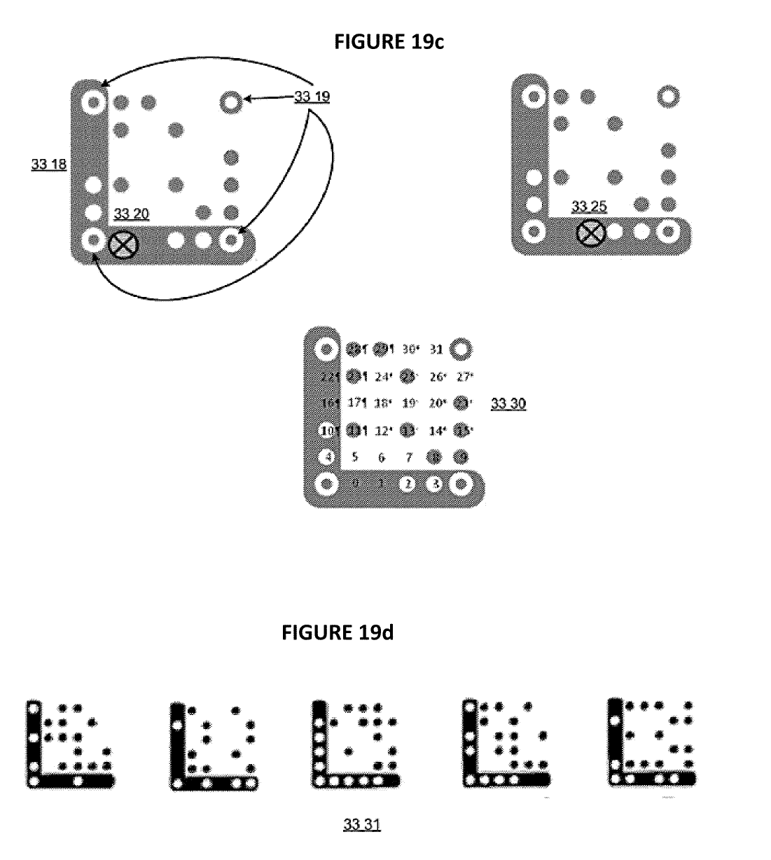

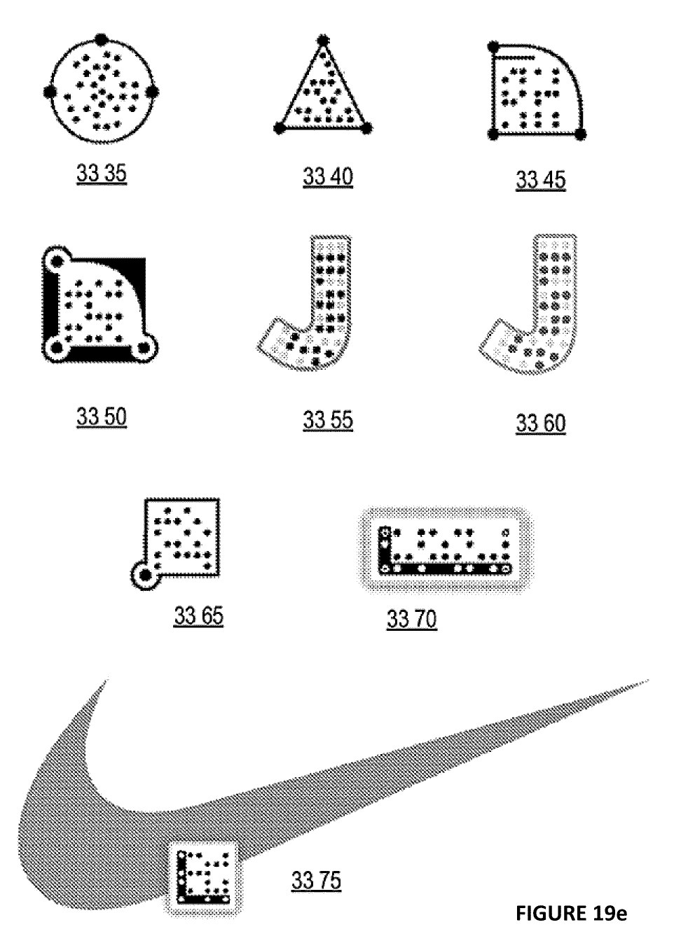

In one implementation, analysis of ambiguous codes may comprise a two-stage process. In a first stage, an encoded string comprising a number of alphanumeric characters, one or more of which may be unclear, may be compared to a database of alphanumeric strings to determine which, if any, match. In one implementation, a Levenshtein distance metric may be employed to determine the similarity of an input string to strings existing in the database. In one implementation, the input string may only be compared against “live” strings in the database (i.e., strings that are currently engaged in active use and/or tied to actual content). If ambiguity remains about which code has been scanned after this character-based analysis, a GCSI/CTIS system may apply a second stage of analysis, whereby the input alphanumeric string is converted into a corresponding binary bitset array (see, e.g., FIGS. 19a-b and associated discussion below) and a comparison is performed between binary values of the input string and the strings stored in the code database. The most significant bits come first in the bitset array while the least significant bits come last, so priority weighting may be applied against potential value matches based on which bits match between the input and stored strings.

### User Interface

FIG. 10b shows an implementation of a user profile user interface in one embodiment of GCSI/CTIS operation. The profile page 1060 may include a display of basic user information 1063 and/or a user picture 1066, and may provide a wide variety of other user information, including demographic information, interests, media libraries, friend lists, coupon code/artifact scanning activities, and/or the like. The displayed implementation further includes a plurality of tabs 1069 allowing the user to view profile information, edit his or her profile, view photos, groups to which the user may belong, and/or edit settings, including sharing and/or privacy settings 1072. Privacy settings may, for example, control access of other individuals to a user's personal information, coupon code/artifact scanning activity, and/or the like. In some implementations, certain information about a user, in particular regarding coupon codes/artifacts that a user has scanned, and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a coupon code/artifact for a CD may also be provided with information about the coupon code/artifact scanning activities of other users whose coupon codes/artifacts also corresponded to CDs.

In one implementation, a user may be allowed to restrict which information of theirs is sent to other users and/or to restrict which information of other users is sent to them. For example, a user may have a “friends” list that has a different level of access than the general public.

In one implementation, a user may have a personal code that is associated with the user and/or a user profile. In one implementation, other users can scan the personal code to automatically join the first user's friend list. In another implementation, a personal code my comprise a short-link to the user's profile 1060, and/or to other profile pages or webpages associated with the user, such as a Facebook page, Myspace page, and/or the like. In one implementation, the user can set a forwarding instruction on his or her GCSI/CTIS page to forward inquiries corresponding to scans of the user's personal code to another page. In another implementation, the user may provide the personal code on other pages as a link back to the user's GCSI/CTIS profile page.

In one implementation, a user may be provided recommendations in response to a coupon code/artifact scan. For example, the user may scan a coupon code/artifact corresponding to a discount on a particular CD by a particular musical artist. The user may then be provided a listing of other CDs, artists, and/or the like having coupon codes/artifacts recently scanned by the members of the user's friends list and/or that may be further related to the CD and/or artist whose coupon code/artifact the user scanned.

In one implementation, a user's coupon code/artifact scans may be integrated with an instant messaging, blogging, micro-blogging, and/or the like service, whereby the user's coupon code/artifact scans are automatically rendered as descriptive summaries and displayed to other users, such as on a webpage, via SMS text messages, emails, and/or the like. For example, each coupon code/artifact scan may have a pre-set text description associated therewith that, upon scanning of the coupon code/artifact, is displayed on a user's Twitter.com page. In one implementation, a user may receive an incentive payment for particular types of content that are provided to the user's friends, associates, blog subscribers, and/or the like as a result of the user's coupon code/artifact scans. For example, a reward may be provided to the user every time the user scans a coupon code/artifact corresponding to a particular brand of products and a message associated with those products is supplied to subscribers to the user's profile and/or blog. A further reward may be provided to the user if it can be determined that one of the user's associates made a purchase based on the provided message.

The privacy settings in the displayed implementation include permissions for displaying “tweets,” songs, videos, and purchases 1075 associated with the user's code scans to various security levels for other people 1078, including the general public, private/friends, and “snaps” (i.e., those who may have scanned a user's personal code and/or a code corresponding to the user's profile). Selection of a particular privacy setting may generate a sharing rule that is stored in association with the user and consulted each time a user scans a code corresponding to one of the categories shown at 1075 to determine whether or not code-associated information should be provided and/or sent to any of the categories of people shown at 1078.

The profile page 1060 further includes a field 1079 wherein a user may specify the location of a data storage facility to which some or all media and/or other content that the user acquires via code scans are to be sent and/or stored. For example, the user may specify an online storage facility (e.g., Apple's iDisk service) in which the user's code scan-acquired content is to be stored. The user code-scan may be linked to a coupon wallet, digital wallet, and the like.

The profile page 1060 further includes interface components configured to generate a personal code, in this case a JagTag 1080. Selection of the button at 1080 causes the GCSI/CTIS system to associate a code with the user and/or the user's profile and generate a corresponding code, which is displayed for the user. The user may then elect to save an image of the code to his or her computer desktop, send the code in an email, send the code in an MMS message, and/or the like via the interface elements at 1081.

In one implementation, virtual coupons may be supplied to a user's mobile device and/or coupon wallet with digital rights management (DRM) software included to prevent or discourage coupon copying, sharing, and/or the like. In another implementation, no DRM software is included with the virtual coupon. It is also possible that DRM software could be implemented through the coupon wallet. This could be implemented by the removal of a virtual coupon from the user's coupon wallet once the coupon is used. Alternatively, unique virtual coupon tags (see FIGS. 10a and 13) could be attached to virtual coupons based on the user's profile and/or elements of the dynamic information (1030). In one embodiment, the virtual coupon could be marked as a one time use coupon. In another embodiment, the virtual coupon could be marked with day/date restrictions, such as an expiration date.

### GCSI/CTIS Media Acquisition Example

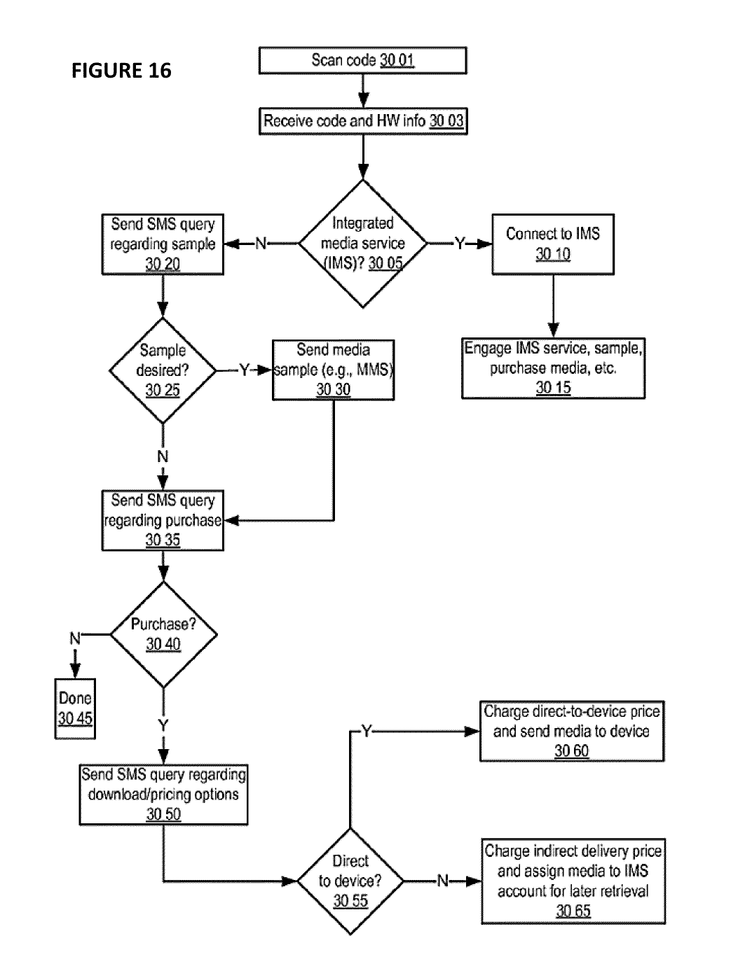

In some embodiments, the GCSI/CTIS may be configured to supply media content for the virtual coupon, music, images, video, and/or the like to users based on the scanning of codes/coupons as described above. Acquisition of full media content may, in some implementations, be preceded by acquisition of media samples that may be reviewed by an acquiring user to determine whether or not to proceed with acquisition of the full content. For example, a billboard may display the Billboard Top 20 songs with a separate code for each song on the list. Consumers, in this example, may scan codes corresponding to each song in the list for which they have interest using a mobile scanning device and receive a sample of each song. In one implementation, a sampling user may further be provided with an opportunity to purchase and/or otherwise acquire the full media content once the sample has been received and/or reviewed. In one implementation, media may be acquired by a user via MMS messaging, while in another implementation, media may be acquired by means of an integrated media service (IMS). The IMS may, in one implementation, comprise an on-demand media service wherein users may maintain accounts, sample and/or purchase media, download and/or upload media, and/or the like. An example of an IMS is Apple's iTunes Store. FIG. 16 shows an implementation of logic flow for media sampling and full media acquisition in one embodiment of GCSI/CTIS operation. A code may be scanned by a user 3001, such as via a mobile device. The scanned code information, as well as hardware information identifying the device, the user, and/or the like may then be received by GCSI/CTIS from the mobile device, such as via a communications network. The GCSI/CTIS may then make a determination, such as may be based on the hardware information, user information, a user profile, and/or the like, as to whether the mobile device is configured with an IMS 3005. If the mobile device is configured with an IMS, the GCSI/CTIS may issue an instruction to the mobile device to connect to the IMS 3010, allowing the user to engage IMS functionality such as the sampling, purchasing, downloading, viewing/playing, and/or the like of media files 3015.

In one implementation, a GCSI/CTIS server may query, store, and/or consider data pertaining to media demographics associated with a particular medium in which a coupon code/artifact is published; the subject content associated with a coupon code/artifact; the type of information requested by scanning a coupon code/artifact; and/or the like. For example, a user scanning a coupon code/artifact associated with a product review for a hybrid sports utility vehicle (SUV) in a men's magazine may trigger a GCSI/CTIS system to draw and/or analyze data pertaining to media demographics associated with the men's magazine, subject content associated with hybrid vehicles (i.e., environmentally conscious consumers), subject content associated with SUVs (i.e., outdoor activity or families), and product reviews. Thus, the GCSI/CTIS may be configured to consider both the subject of a user's inquiry, the source of the inquiry, the type of inquiry, and/or the like.

In another embodiment, the GCSI/CTIS may allow users to instantly subscribe to and/or enroll in services, loyalty programs, discount programs, and/or the like by scanning codes associated therewith. For example, a user may enroll in a brand-affiliated coupon program by scanning a code associated with that program. Selection of a subscription and/or enrollment code may cause the GCSI/CTIS to submit a user's personal information to an integrated subsystem and/or third-party system for subscription registration. In some implementations, the GCSI/CTIS may require verification from the user, separate from the coupon code/artifact scan itself that the user wishes to enroll and/or subscribe to the associated service. In some implementations, a user may submit trigger specifications and/or conditions for enrolled service notifications. For example, a user may specify that he or she only wishes to receive coupons for products from a particular grocery store and not from other grocery stores. Scanning of a coupon code/artifact associated with a subscription program wherein specification of triggers and/or conditions is permitted may cause a GCSI/CTIS system to retrieve and display a user interface screen to the user that is tailored to the particular subscription and/or enrollment service and configured to receive trigger and/or condition specifications. In one embodiment, the enrollment in a loyalty or discount program may enable virtual coupons for the user, which are not available to the general public. This could be virtual coupons that are active earlier than general public virtual coupons, are for a greater discount, and/or the like.

In another embodiment, the GCSI/CTIS may be configured to track and/or implement a rewards program. For example, in a single-tiered rewards program implementation, a user may scan a code every time he or she purchases a particular item (e.g., a sandwich from the local sandwich shop) in order to register each purchase and store a record thereof in association with the user. The user may then receive a discount, free item, and/or the like after a pre-designated number of purchases and associated scans are registered, after which the record of scans is reset to start anew. In another example, in a multi-tiered rewards program implementation, a user may continue to register additional purchases and associated code scans to receive larger and/or more significant benefits, discounts, and/or the like. The user's coupon wallet could be implemented to automatically monitor purchases associated with rewards programs, and deliver/notify once the coupon is enabled. In this way, the virtual coupon would be created in place of a physical reward card, and be capable of storage either in a user's digital device local storage or in the user's coupon wallet.

In another implementation, a virtual coupon provider may submit just a first visual token and response content and/or a means of addressing said content, and a GCSI/CTIS server may generate a corresponding code-serving interface, a dial-in code and/or SMS and/or MMS address, hyperlink, and/or the like to allow users to interact with the first visual token to receive the response content. In one implementation, the generated code-serving interface may include HTML markup information enabling it to be embeddable on any webpage. A fee may be charged to the content provider, such as on a pay-per-click basis, for user interactions with the generated code-serving interface.

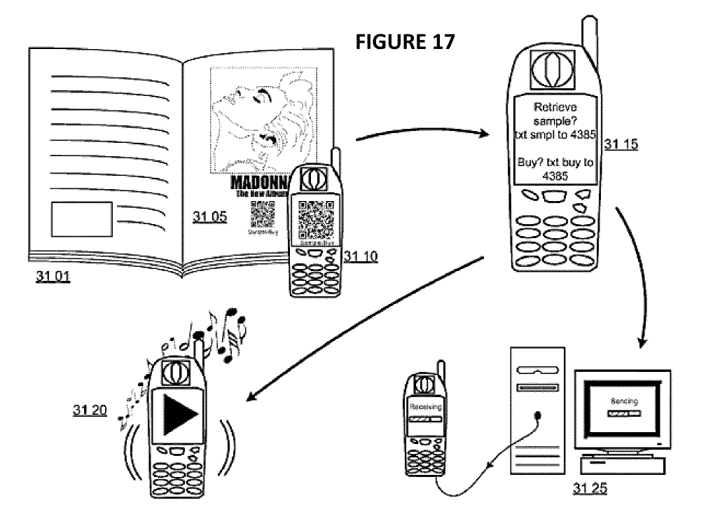

FIG. 17 shows an illustration of media acquisition in one embodiment of GCSI/CTIS operation. In the illustrated implementation, a printed publication 3101 displays an advertisement for a new release by a recording artist 3105, the advertisement including a scannable matrix code that facilitates the acquisition of media associated with the new release by a user. In an alternative implementation, an animated user interface may present a scannable code on a proximate side of a first image, such as on a video billboard, website, television program, and/or the like. The media may, for example, comprise an entire album, a single, a ringtone, a video, an image, and/or the like. In one implementation, the media provided may depend on the scanned code in conjunction with a user profile containing user preferences, a history of user behavior and/or prior scanned codes, and/or the like. The user may engage the media content by scanning the code with his or her mobile device 3110, after which the GCSI/CTIS may query the user, such as via an SMS text message, as to whether or not he or she wishes to sample and/or purchase the requested media 3115. The user may respond, in one implementation, by sending a reply text message to be relayed to the GCSI/CTIS. In one implementation, the GCSI/CTIS may subsequently provide, stream, upload, and/or the like the requested media directly to the user's mobile device for storage and/or playback 3120. In another implementation, the GCSI/CTIS may provide the requested media to an intermediary storage facility, such as a user's media service account, an email server, an ftp server, and/or the like. The user may then subsequently procure the media from the intermediary storage facility, transfer the media to a mobile device, and/or the like 3125 at a later time.

In still another implementation, a webpage or other display area may include a generic placeholder for code-serving interfaces that may be filled by code-serving interfaces and/or associated content supplied from one or more advertisement servers and/or GCSI/CTIS servers. The supplied code-serving interfaces may be selected based on webpage content, contextual cues, and/or the like and/or based on the goals of content providers and/or code-serving interface creators. For example, an advertiser may wish to place a particular code-serving interface associated with a new action movie on any webpage having a generic placeholder that mentions extreme sports. A fee may be charged to an advertiser for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

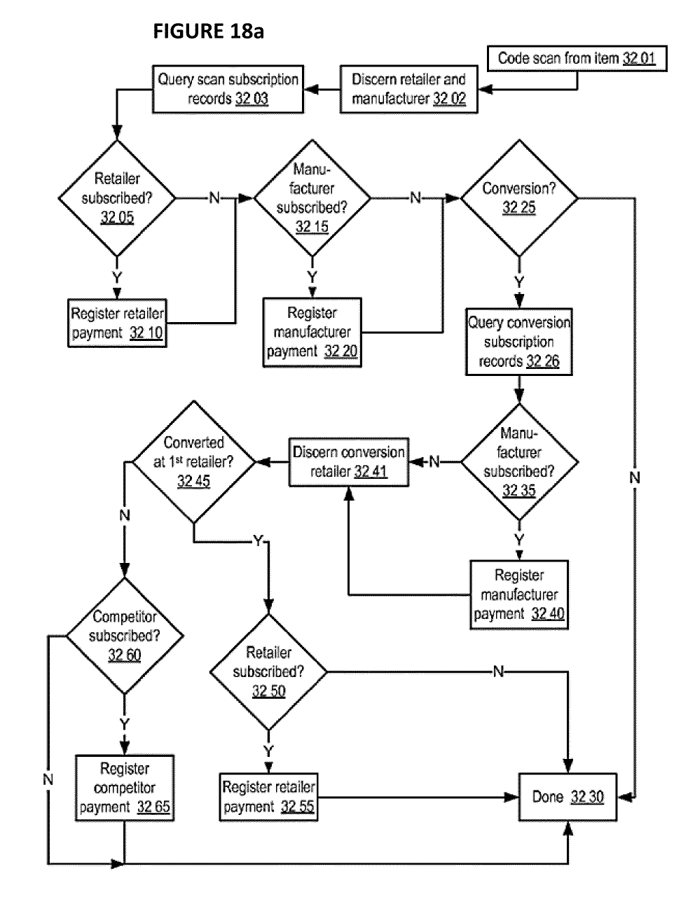

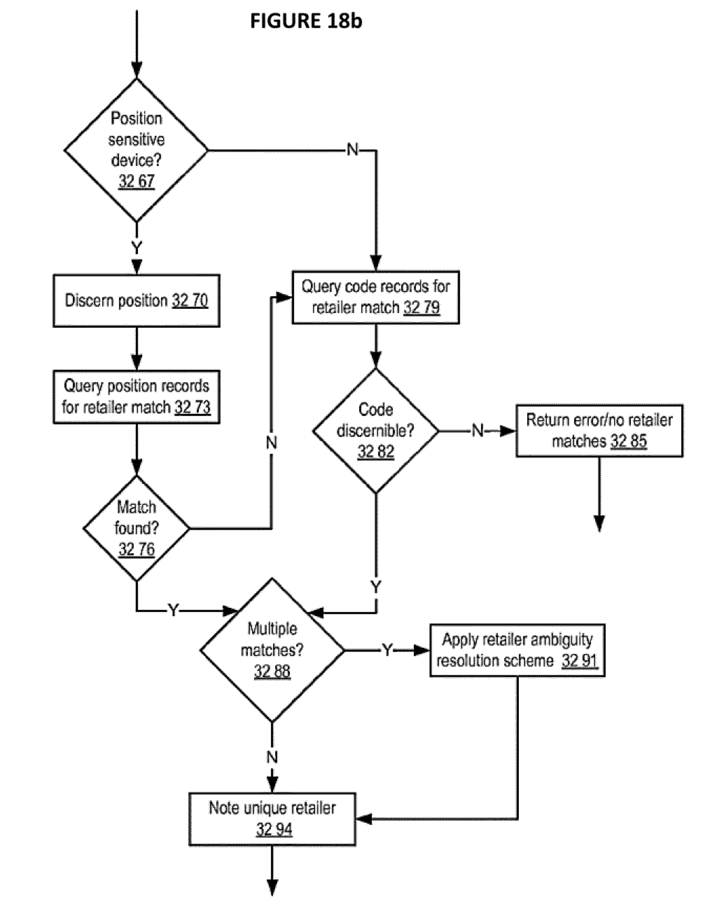

FIGS. 18a-b show an implementation of logic flow for code scan monetization in one embodiment of GCSI/CTIS operation. In FIG. 18a, a code is scanned at 3201. In the illustrated implementation, the code may be found on a physical item that is subject to purchase and may be found in a retail establishment. For example, a compact disc (CD) in a music store may be embellished with a scannable coupon code/artifact that, when scanned, may provide a sample of the music stored on the CD, deliver a ringtone to the user's mobile scanning device, provide artist information, images, concert dates, cause delivery of a virtual coupon, and/or the like. In another implementation, the item for purchase may not be physical but rather may be provided online, such as on a website, and an associated coupon code/artifact may be provided on the page on which the item is offered for purchase. Once the coupon code/artifact is scanned 3201, a determination may be made as to whether the retailer providing the item is subscribed to a GCSI/CTIS service 3205. In one implementation, the retailer may be discerned based on a geographic position provided to the GCSI/CTIS by a code message sent from the user's mobile device that may, for example, be compared to records of retailer locations. The geographic position may be determined, for example, by an on-board GPS unit on the user's mobile device or based on geographic information contained in the scanned code. Subscription to the service may, for example, entail licensing to embellish items with GCSI/CTIS affiliated coupon codes/artifacts in exchange for a fee, such as a one-time or periodic fee and/or a per-scan fee, such as illustrated in the implementation shown in FIG. 17. If the retailer is determined at 3205 to be a subscriber, then the GCSI/CTIS may register a retailer payment 3210. For example, in one implementation, registering payment may comprise noting the fee in a fee record. In an alternative implementation, the GCSI/CTIS may automatically deduct the fee from a pre-designated account. A determination may also be made as to whether the manufacturer, publisher, distributor, and/or the like of the item in question is a subscriber 3215. For example, for the case of the CD discussed above, the “manufacturer” may comprise a record label. If the manufacturer is determined to be a subscriber, then a manufacturer payment is registered at 3220.

Discernment of retailer, competitor, and/or manufacturer identities may be accomplished by a variety of different schemes in various implementations and/or embodiments of GCSI/CTIS operation. For example, a unique subset of coupon codes/artifacts may be reserved for a particular manufacturer, retailer, and/or the like, such that a scan message corresponding to any coupon code/artifact of the unique subset may be associated by a GCSI/CTIS system with the particular manufacturer, retailer, and/or the like. In another implementation, retailers associated with a given scanned coupon code/artifact may be discerned based on a geoposition of the mobile scanning device at the time of coupon code/artifact scanning FIG. 18b provides an illustration of an implementation of logic flow for discerning retailers in one embodiment of GCSI/CTIS operation. A determination is made at 3267 as to whether the mobile scanning device used to scan a coupon code/artifact is position sensitive. Position sensitivity of a mobile device may be facilitated, for example, by an on-board GPS unit, mobile device and/or cellular tower triangulation, trilateration, multilateration, and/or the like. If the device includes one or more position sensitive facilities, the GCSI/CTIS may discern the position of the mobile device 3270. Position discernment by the mobile device and/or the GCSI/CTIS may include drawing raw geographic position data from one of the facilities described above using, for example, mobile device software development kit (SDK) tools, an example of which are those associated with the iPhone SDK toolkit. The GCSI/CTIS system may then query position records based on the position discerned at 3270 to seek retailers matching that position 3273. A determination is made at 3276 as to whether any matching retailers are found. If no retailers match the discerned mobile device position, or if the mobile device lacks position sensitivity at 3267, the GCSI/CTIS system may query virtual coupon code records based on the scanned coupon code/artifact received from the mobile device to seek retailers matching the scanned coupon code/artifact 3279. A determination is made at 3282 if any retailers are code discernible and, if not, then the GCSI/CTIS may return an error message and/or record that no matching retailer was found 3285. If any matches are found either by position or code discernment, then a determination may be made as to whether there exist multiple retailer matches 3288. If not, then the unique matching retailer may be recorded, provided to facilitate subsequent code scan monetization, and/or the like 3294. If multiple retailer matches exist, the GCSI/CTIS system may apply one or more retailer ambiguity resolution schemes 3291 in order to narrow down the results to a unique retailer match. A wide variety of ambiguity resolution schemes may be employed within different implementations and/or embodiments of GCSI/CTIS operation. For example, in one implementation, a GCSI/CTIS system may consult a user profile associated with the user who's mobile device issued the code scan to determine whether the user's code scan history indicates a preference for a particular retailer, retailer type, and/or the like which may assist in further discerning the unique retailer associated with the current code scan. In another implementation, the GCSI/CTIS system may provide a plurality of possible retailer matches in a message (e.g., an SMS message) to a user's mobile device and request feedback as to which retailer is the correct one in whose establishment the coupon code/artifact was scanned.

A determination may then be made as to whether a conversion has taken place whereby the user has actually purchased the item associated with the scanned coupon code/artifact. In one implementation, the GCSI/CTIS may monitor activity on a credit card associated with a user account once that user has registered a coupon code/artifact scan. A subsequent purchase using the associated credit card may then register a conversion with the GCSI/CTIS. If no conversion is detected, such as within a pre-designated period of time, then the code scan monetization is complete for the particular code scan 3230. If, on the other hand, a conversion is registered, then a determination may be made as to whether the manufacturer is subscribed to pay further fees upon item conversion 3235. If so, then the additional manufacturer payment for conversion is registered at 3240.

A determination may be made as to whether the conversion, i.e., the purchase of the coupon code/artifact-associated item, was made at the retailer at which the coupon code/artifact was scanned 3245. If so, then a determination may be made as to whether the retailer is subscribed to pay an additional fee associated with item conversion 3250. If so, that payment is registered at 3255. If the conversion occurs at a competitor retailer different than the original retailer at which the item-associated coupon code/artifact was scanned (e.g., another brick-and-mortar retailer, another website, etc.), a determination may be made as to whether the competitor retailer is subscribed to pay a fee for item conversion 3260. If so, then the competitor payment may be registered at 3265. In one implementation, a competitor may be permitted to supply a message (e.g., an SMS text message, and/or the like) to a user's mobile device when the user scans coupon codes/artifacts associated with particular items at particular retail locations in order to entice the user to purchase the item from the competitor instead of at the particular retail location in which the coupon code/artifact was scanned. The competitor message may, for example, include an additional virtual coupon and/or other discount on the sale price of the coupon code/artifact-associated item. In one implementation, the competitor may be charged a separate fee for being allowed to supply such messages, such as a per-message fee, a one-time or periodic fee, and/or the like.

In some implementations, fees charged to manufacturers, retailers, and/or competitors may be substantially the same. In alternative implementations, different fees may be charged to manufacturers, retailers, and/or competitors.

FIGS. 19a-e show aspects of implementations of JagTag encoding and coupon codes in some embodiments of GCSI/CTIS operation. FIG. 19a shows an implementation of logic flow for JagTag encoding in one embodiment of GCSI/CTIS operation. An alphanumeric string may be associated with content to which a JagTag code is ultimately to be associated 3301. In one implementation, a five character string is employed. Each character of the alphanumeric string may then be converted into a corresponding integer, such as may be based on a correspondence table 3302. FIG. 19b shows an implementation of such a corresponding table relating decoded characters, including lowercase letters 3313, numbers 3314, and uppercase letters 3315, to encoded values 3316 comprising integers between 0 and 62. To convert the alphanumeric string into a JagTag code, each character in the string is converted into a corresponding integer between 0 and 62 using the table in FIG. 19b. A determination may then be made as to whether any of the characters comprise punctuation marks or other unrecognizable or unconvertable characters 3303. If so, those characters are set to blanks or zeros in the resulting string of integers 3304. A determination may also be made as to whether the number of characters in the alphanumeric string exceeds a pre-designated maximum number 3305 (e.g., 5 characters). If so, additional characters are ignored 3306.

Each resulting integer may then be converted to a corresponding binary value 3307, and a determination may be made as to whether there are a sufficient number of “on” bits (i.e., bits equal to 1) 3308. For example, the GCSI/CTIS may require the existence of at least some minimum number (e.g., 9) of on bits. If not, then the system may return an error message and/or recommend that the user try a different initial alphanumeric string 3309. Otherwise, the GCSI/CTIS system may concatenate the string of binary numbers to yield a single 32-bit long bitset array 3310. The system may then generate a JagTag bit representation 3311, as described below, and output the resulting JagTag to a physical display and/or storage (e.g., storing an image formatted JagTag in a database, printing the JagTag, displaying the JagTag on a display screen, and/or the like) 3312.

The first bit of the bitset array may be considered a most-significant bit and the last bit of the bitset array may be considered a least-significant bit. Once complete, the 32-bit binary bitset array may be converted into a JagTag code representation. FIG. 19c further illustrates JagTag encoding in one implementation. The JagTag may include an L-shaped component 3318 that may, in one implementation, promote orientational and/or size discrimination of the JagTag, such as by a scanning or analyzing device. The JagTag may further include four circular elements 3319 that may also serve to promote orientational and/or size discrimination. The most significant bit of the bitset array may be encoded as a circle at the position indicated by the crossed circle at 3320, with a white circle (owing to the dark background of the L-shaped component 3318) indicating a 1 and no circle indicating a 0. The next most significant bit of the bitset array, then, may be encoded as a circle at the position indicated by the crossed circle at 3325. The numbering scheme indicated at 3330 shows how the circles (or lack of circles) at positions numbered from 0 to 31 correspond to the bits in the 32-bit bitset array, with 0 the most significant bit and 31 the least significant bit. If the bit falls on the L-shaped component 3318, a white circle is drawn for a bit value of 1, and otherwise a dark circle is drawn for a bit value of 1.

In one implementation, a shell script may be configured to accept an alphanumeric string comprising characters to be encoded and to return a JagTag in an image format, such as a PNG, JPG, GIF, BMP, and/or the like file format. In one implementation, the shell script may be further configured to receive a color specification (e.g., an HTML-style RGB triplet).

Configuring a JagTag for optimal recognition may be accomplished in a variety of different ways within different implementations. For example, a color for the JagTag code may be selected to as to have high contrast with the background color. A high number of “on” bits (i.e., bits equal to 1) may also improve code recognition, as discussed above. Accordingly, in one implementation, resulting JagTag codes having less than a minimum number of on bits may be rejected. Other measures that may be taken in various implementations to improve JagTag recognition may include maximizing code dimensions, ensuring that the code is surrounded by a substantial margin (e.g., at least 25% of the code's width and height), and ensuring fidelity of the code by eliminating any obscuring interferences. JagTag codes may be configured for a wide variety of physical manifestations, including printing on magazine pages, billboards, newspapers, physical coupons and/or the like, displaying on video display screens, television broadcasts, websites, and/or the like. JagTags may also be configured into different shapes or display configurations in various implementations.

FIG. 19d shows one non-limiting embodiment of data loss resilient codes 3331, with characteristics that include: reducing errors based on “bleeding” of encoded data points by using circles/dots rather than squares that touch each other (this combats fuzziness of image as well as reduced light conditions); using a stronger identifier to discover processing directionality (rotation, skew, slant)—this is the black line with white dots shown in the figure; including data points within the identifier in order to maximize encoded data as well as allow for reduction in size of code; using equidistant lengths on identifier to process for skew and slant; using constant data points within the directional identifier to process for skew and slant—this may be top left, bottom right and bottom left white dots (not indicated in FIG. 19d); reducing the amount of data encoded in the code—most likely 5-8 characters—in order to allow for size reduction of the code; developing code characteristics so partial decoding allows for matching code to correct data on the server—for example, if only 70% of the characters from a code are discernible, the GCSI/CTIS can use server logic to extrapolate what the code is as well as the campaign/client it's associated with, i.e., information about the exact publication the code is in may be lost, but the GCSI/CTIS system can figure out the campaign and return an appropriate message; with regard to partial decode matching, server side and database logic focuses both on creating codes for clients and campaigns that are unique sets in order to enable partial decode matching as well as providing a set of rules around time, mobile number, and likelihood in order to determine the best potential match for partial decodes.

In the embodiment of the basic codes 3331 shown in FIG. 19e, design wrapped around the code does not impact the effectiveness of the decoding. High tone color differentials are allowed, so rather than black, dark blue or red could be used. The white dots in the identifiers are less likely to allow for color changes although a very light yellow or gray may be allowed.

In a further embodiment, the dots most likely to be lost in an image may be assessed and the least useful information encoded appropriately based on that assessment. An interesting opportunity for this code is that it allows for some logos to potentially replace the dots. For example, an Alltel logo can be used nearly as well as the dots, or a Nike logo is decodable with some server side code modifications.

The codes have an additional benefit in that they are in and of themselves, aesthetically pleasing, and as such offer significant advantages over previous codes. The ability in one embodiment, to vary the colors of the code, allows it to better integrate and look better in marketing contexts.

FIG. 19e shows some implementations of alternative JagTag display configurations, including circular 3335, triangular 3340, modified squares (3345, 3350, 3365), rectangular 3370, letter shaped (J shapes shown at 3355 and 3360), and/or the like. JagTags may also be displayed in proximity to and/or integrated with other codes, logos, insignias, and/or the like, such as shown at 3375.

### Connecting Users

### Forming Groups

In another embodiment, the CTIS is configured to connect users based on user profiles. For example, in analogy to the “provider zone” breaches discussed above, the CTIS may also track the intersection of user space-time trajectories. In particular, if one user is within a specified distance of the projected space-time trajectory of another user with whom the first user is associated, a message may be sent to one or both users notifying them of their potential proximity. Further consideration of user profiles may also be utilized in such notifications.

As previously described and illustrated in FIG. 10b, a user program interface provides a user to access semi-static profile information and add new information or edit existing information. The user may also establish a friends list and regulate which elements of the semi-static and dynamic portions of the user profile may be shared with “friends.”

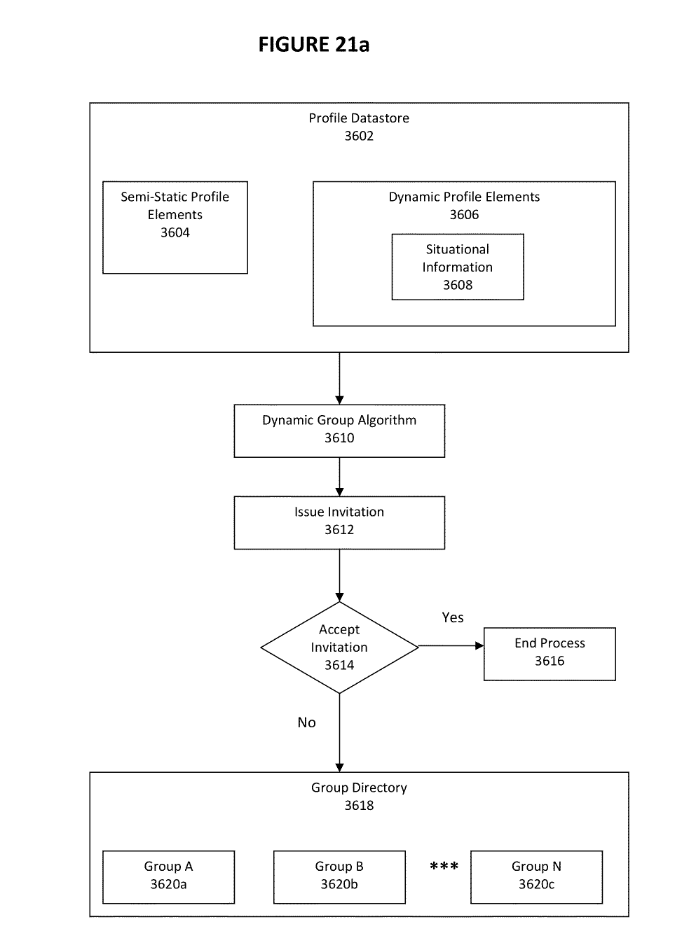

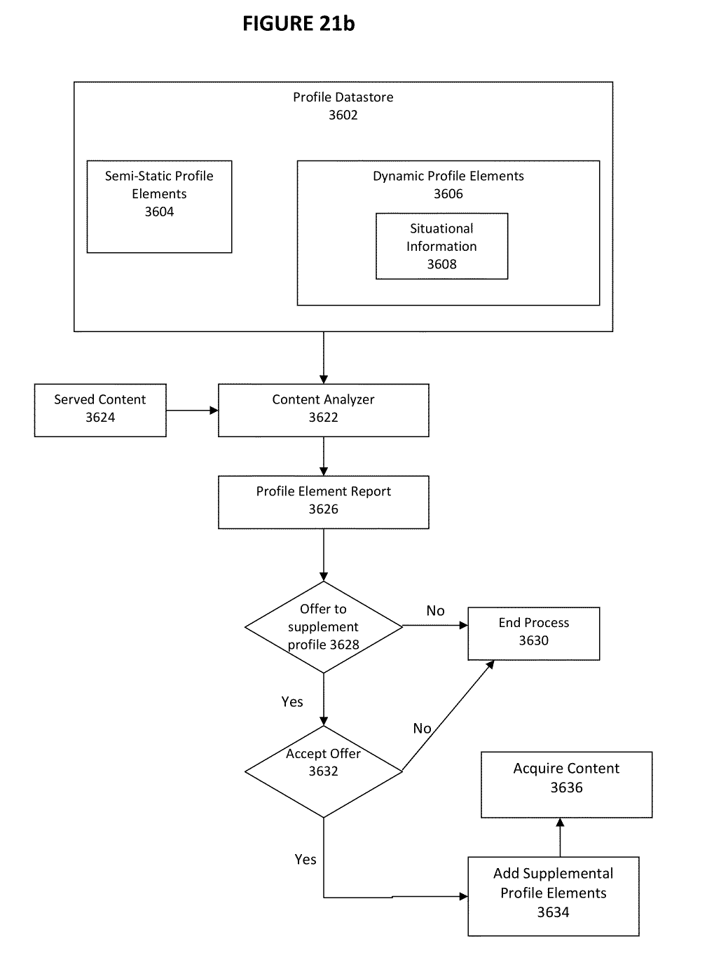

FIG. 21A is a block diagram illustrating a CTIS configured to assign users having similar interests and situational information into dynamic groups according to an embodiment.

In an embodiment, the semi-static elements (3604) and the dynamic elements (3606) in a profile datastore (3602) are accessed by a dynamic group algorithm (3610) operating on a CTIS. The dynamic group algorithm (3610) identifies groups appropriate for a particular user of the CTIS. An invitation to join a group is issued to the particular user (3612). A determination is made whether the particular user accepts the invitation to join a particular group (3614). If the user declines the invitation, that is, the result of 3614 is “NO,” the process ends (3616). If the user accepts the invitation, that is, the result of 3614 is “YES,” the user is assigned to a group (3620a, 3620b, . . . , 3620n) and a record is made in a group directory (3618). By way of illustration and not by way of limitation, a user may accept and invitation to join Group A but not Group B, may join both Group A and Group B, or reject the invitation to join any of the Groups identified by the dynamic group algorithm (3610).

In an embodiment, the logic of 3614 is reversed. That is, the user must affirmatively opt-out of the group assignment made by the CTIS.

As illustrated in FIG. 21A, the dynamic group algorithm (3610) evaluates both semi-static elements (3604) and dynamic elements (3606) of a user profile to determine what groups are appropriate for a particular user. The dynamic profile elements (3606) may include situational information (3608). Situation information may include a location of a user and a trajectory of a user. Using this information, the dynamic group algorithm may group users of the CTIS with similar profiles who are in geographic proximity to each. The geographic proximity may be as large as a city and as small as a bar, a trade show, and a concert venue.

Group members typically share core information, such as a user name. In an embodiment, a group member may specify the personal information he or she is will to share with other group members. A group member may also specify which group members it prefers to be “invisible” to. In an embodiment, the sharing of the user name allows the group members to communicate via the CTIS but does not provide direct communication to between group members. Thus, the CTIS operates a communication proxy to allow group member to be restrict communications from particular members of the group or all members of the group.

In an embodiment, the core information for a particular group may be determined by the group's purpose. The group purpose may also be associated with a particular rule set that determines how the core personal information is shared. For example, in group whose purpose is facilitate social interactions, age, religious preferences, music preferences and other personal interest details may be part of the core information. In a group whose purpose is to facilitate business interactions, the core information may be limited to professional information and information relating to products and services.

In another embodiment, the situational information (3608) may identify users the CTIS with similar profiles who are participating in a common virtual world. Users with these attributes may be assigned to a group for that particular virtual world. In this example, the core information may be specific to the virtual world and the particular user's historical interaction with that world.

Users of the CTIS with similar profiles, who are skiing, albeit in different locations, may be assigned to yet another group that utilizes a core information rule set that is specific to skiing. Users at the same ski resort may be assigned to a group specific to that resort. The shared information rule set for this group may include an option that allows members to provide indentifying information to facilitate in-person meetings.

The membership of a group may be constantly in flux as the situational information (3608) of the group members changes. In an embodiment, members of a dynamic group may make the group permanent by adding some or all of the members to a friends list associated with a group name.

FIG. 21B is a block diagram illustrating a CTIS configured to identify profile elements that are related to specific content according to an embodiment.

As previously described, users with substantially similar semi-static profile elements (3604) who scan a particular code may receive different content based on differences in their dynamic profile elements (3606).

In an embodiment, a second user who has not received particular content may request the CTIS to compare the profile of the first user with the profile of the second user to determine what factors in the dynamic elements of the first user's profile caused the content to be served to the first user but not the second user. A content analyzer (3622) receives content or a content identifier that was received by a first user of the CTIS. The content analyzer also receives the semi-static profile elements (3604) the dynamic profile elements (3606) of a second user of the CTIS from the profile datastore (3602). The content analyzer (3622) evaluates the served content and the profile data to determine what profile elements could be added to the second user's profile for the second user to receive the served content. The content analyzer generates a profile report (3626).

For example, a first user may receive a coupon for a free beverage from a vendor in response to the user passing the vendor's physical location or browsing to the vendor's website. In order to obtain the coupon, the second user may be required to travel to the physical site or navigate to the vendor's website. Note that this process differs from embodiments in which a coupon may be shared, in that the second user is compelled to engage the vendor at some level to obtain the coupon. From the vendor's perspective, the value of the coupon is used to incentivize the second user to engage the vendor.

In many cases, the reasons for serving the content to the first user may be more complex than suggested in the example. For example, a coupon may have been served to the first user based on the first user's history of interest in beverages and purchases made from the vendor or establishments similar to the vendor. Even if the second user were to visit the physical or virtual location of the vendor, the second user may not meet the requirements for receiving the coupon.

In an embodiment, the CTIS may optionally offer to supplement the second user's profile to include elements that would qualify the second user for the served content (3628). If the CTIS does not make an offer to supplement the second user's profile, that is, if the result of 3628 is “NO,” the process ends (3630). If the CTIS makes an offer to supplement the second user's profile, that is, the result of 3630 is “YES,” then a determination is made whether the second user accepts the offer (3632). If the second user rejects the offer, that is, the result of 3632 is “NO,” the process ends (3630). If the second user accepts the offer, that is, the result of 3632 is “YES,” the second user's profile is assigned supplemental profile elements (3634). The “supplemental” profile elements may be stored separately from other elements and may be temporary with a defined “time-to-live” or may be permanently stored in association with the user's identifier. The served content is acquired using the supplemental profile elements (3636).

In an embodiment, a code or token may be provided to the second user that could be presented by the second user to the physical or virtual location of the vendor that would cause the coupon to be served to the second user without regard to the second user's profile. In an embodiment, the token or code may be provided only with the vendor's consent.

### Reduced Printing

In another embodiment, the CTIS allows for reduced use of printed space in media publications or printed coupons. For example, an ordinary printed article or advertisement may be supplanted by a 2D matrix code that supplies the content directly to the user's mobile display device. Furthermore, the supplied content may be dressed with additional content that is specifically chosen for the user based on his/her profile or current location, thus increasing the value and utility of the content/virtual coupon while still utilizing significantly reduced print space. This increased content value, coupled with the reduction in print space, may translate to significantly increased advertising revenue for media publications. In another embodiment, scan coupon codes/artifacts may be placed in web-based ads so that users may scan those ads with their mobile device. In another embodiment, scan coupon codes/artifacts may be placed in television-based advertisements or programs.

A method of creating a virtual coupon from a physical coupon, comprising: receiving multi-modal artifact data scanned from a multi-modal artifact present in the physical coupon; communicating at least some of the multi-modal artifact data to a data repository; comparing the communicated data with data present in the data repository; and sending at least one reply message from the data repository based upon the communicated data. The scanned multi-modal artifact data may comprise data representative of at least one sensory input of visual, auditory, haptics, olfactory, or gustatory. The scanned multi-modal artifact data comprises data that is representative of a barcode, 2D code, 3D code, 3D-VR code, matrix code, data matrix, QR code, Near Field Communications (NFC) tag, Radio Frequency Identification (RFID) tag, Bluetooth, Infrared, and/or Wireless communication. The scanned multi-modal artifact data comprises data that is associated with a printed coupon or advertisement, and/or a broadcasted coupon or advertisement. The data repository may comprise a digital application on a mobile communication device. The data repository may comprise a component of a code triggered information server database. The code triggered information server database communicates with a third party provider. The communicated data may comprise a user ID, a hardware ID, a geocode, a timestamp, a subject code, a source code, and/or a content code. The least one reply message is selected from the group consisting essentially of: a virtual coupon associated with the scanned multi-modal artifact, a discount code associated with the scanned multi-modal artifact, or a user query associated with the scanned multi-modal artifact. The virtual coupon is redeemed immediately by a user. The virtual coupon is stored based on a user's interaction with the reply message. The virtual coupon is stored in a digital device's local storage. The virtual coupon is stored in a second data repository. The second data repository is tied to a user profile. The second data repository is a digital coupon wallet. The method may comprise retrieving the virtual coupon based on a user request. The method may comprise communicating the retrieved virtual coupon to a point of sale system. The point of sale system is associated with a 3^{rd} party system. The communication of the retrieved virtual coupon is by NFC, IR, SMS, MMS, instant messaging, web browser based messaging, email, Enhanced Messaging System, TCP/IP, WAP, and/or barcode. The method may comprise removing the retrieved virtual coupon after communication to the point of sale system. The method may comprise recording a fee based on a response to the at least one reply message. The method may comprise recording a fee based on the communication of the retrieved virtual coupon to the point of sale system.

A method of notifying a user of a virtual coupon created from a physical coupon, comprises: scanning multi-modal artifact data from a multi-modal artifact; communicating at least some of the scanned multi-modal artifact data to a data repository; comparing the communicated data with data present in the data repository; sending at least one reply message from the data repository based upon the communicated data; storing a virtual coupon based upon the communicated data and a response to the at least one reply message; and providing a notification to the user of the stored virtual coupon when a condition is satisfied. The multi-modal artifact may comprise data being representative of at least one sensory input of visual, auditory, haptics, olfactory, or gustatory. The multi-modal artifact may comprise data that is representative of a barcode, 2D code, 3D code, 3D-VR code, matrix code, data matrix, QR code, Near Field Communications (NFC) tag, Radio Frequency Identification (RFID) tag, Bluetooth, Infrared, and/or Wireless communication. The multi-modal artifact may comprise data that is associated with a printed coupon or advertisement, and/or broadcasted coupon or advertisement. The data repository may comprise a digital application on a mobile communication device. The data repository may comprise a component of a code triggered information server database. The code triggered information server database communicates with a third party provider. The communicated data further comprises a user ID, a hardware ID, a geocode, a timestamp, a subject code, a source code, and/or a content code. The at least one reply message is selected from the group consisting essentially of: a virtual coupon associated with the scanned multi-modal artifact, a discount code associated with the scanned multi-modal artifact, or a user query associated with the scanned multi-modal artifact. The virtual coupon is stored in a digital device's local storage. The virtual coupon is stored in a second data repository. The second data repository is tied to a user profile. The second data repository is a digital coupon wallet. The condition is a date or a location of the user. The condition may comprise a predicted location of the user. The condition may comprise a second scanned multi-modal artifact. The condition is based on a user profile. The method may comprise retrieving the virtual coupon based on a user response to the notification. The method may comprise communicating the retrieved virtual coupon to a point of sale system. The point of sale system is associated with a 3^{rd} party system. The communication of the retrieved virtual coupon is by NFC, IR, SMS, MMS, instant messaging, web browser based messaging, email, Enhanced Messaging System, TCP/IP, WAP, and/or barcode. The method may comprise recording a fee based on a user response to the notification.

A system for creating a virtual coupon from a physical coupon, comprises: a processor coupled to a mobile communication device; a memory in communication with the processor and containing program instructions; an input and output in communication with the processor and memory; wherein the processor executes program instructions contained in the memory and the program instructions comprise: receiving multi-modal artifact data scanned from a multi-modal artifact present in the physical coupon; communicating at least some of the multi-modal artifact data to a data repository; comparing the communicated data with data present in the data repository; and sending at least one reply message from the data repository based upon the communicated data. The multi-modal artifact comprises data being representative of at least one sensory input of visual, auditory, haptics, olfactory, or gustatory. The multi-modal artifact comprises data that is representative of a barcode, 2D code, 3D code, 3D-VR code, matrix code, data matrix, QR code, Near Field Communications (NFC) tag, Radio Frequency Identification (RFID) tag, Bluetooth, Infrared, and/or Wireless communication. The multi-modal artifact comprises data that is associated with a printed coupon or advertisement, and/or broadcasted coupon or advertisement. The data repository comprises a digital application on a digital device. The data repository comprises a component of a code triggered information server database. The code triggered information server database communicates with a third party provider. The communicated data further comprises a user ID, a hardware ID, a geocode, a timestamp, a subject code, a source code, and/or a content code. The at least one reply message is selected from the group consisting essentially of: a virtual coupon associated with the scanned multi-modal artifact, a discount code associated with the scanned multi-modal artifact, or a user query associated with the scanned multi-modal artifact. The virtual coupon is redeemed immediately by a user. The virtual coupon is stored based on a user's interaction with the reply message. The virtual coupon is stored in a digital device's local storage. The virtual coupon is stored in a second data repository. The second data repository is tied to a user profile. The second data repository is a digital coupon wallet. The system may comprise retrieving the virtual coupon based on a user request. The system may comprise communicating the retrieved virtual coupon to a point of sale system. The point of sale system is associated with a 3^{rd} party system. The communication of the retrieved virtual coupon is by NFC, IR, SMS, MMS, instant messaging, web browser based messaging, email, Enhanced Messaging System, TCP/IP, WAP, and/or barcode. The system may comprise removing the retrieved virtual coupon after communication to a purchase system. The system may comprise recording a fee based on a user response to the at least one reply message. The system may comprise 9+ recording a fee based on the communication of the retrieved virtual coupon to the point of sale system.

What is claimed is:

1. A method of creating a virtual coupon from a physical coupon, comprising:
Receiving multi-modal artifact data scanned from a multi-modal artifact present in the physical coupon;
Communicating at least some of the multi-modal artifact data to a data repository;
Comparing the communicated data with data present in the data repository; and
Sending at least one reply message from the data repository based upon the communicated data.

2. The method of claim 1, wherein the scanned multi-modal artifact data comprises data representative of at least one sensory input of visual, auditory, haptics, olfactory, or gustatory.

3. The method of claim 1, wherein the scanned multi-modal artifact data comprises data that is representative of a barcode, 2D code, 3D code, 3D-VR code, matrix code, data matrix, QR code, Near Field Communications (NFC) tag, Radio Frequency Identification (RFID) tag, Bluetooth, Infrared, and/or Wireless communication.

4. The method of claim 1, wherein the scanned multi-modal artifact data comprises data that is associated with a printed coupon or advertisement, and/or a broadcasted coupon or advertisement.

5. The method of claim 1, wherein the data repository is selected from the group consisting of: a digital application on a mobile communication device; and a component of a code triggered information server database.

6. The method of claim 5, wherein the code triggered information server database communicates with a third party provider.

7. The method of claim 1, wherein the communicated data further comprises a user ID, a hardware ID, a geocode, a timestamp, a subject code, a source code, and/or a content code.

8. The method of claim 1, wherein the at least one reply message is selected from the group consisting essentially of: a virtual coupon associated with the scanned multi-modal artifact, a discount code associated with the scanned multi-modal artifact, or a user query associated with the scanned multi-modal artifact.

9. The method of claim 8, wherein the virtual coupon is selected from the group consisting of: redemption immediately by a user; stored based on a user's interaction with the reply message; stored in a digital device's local storage; and stored in a second data repository.

10. The method of claim 9, wherein the second data repository is selected from the group consisting of: tied to a user profile, and a digital coupon wallet.

11. The method of claim 9, further comprising retrieving the virtual coupon based on a user request; communicating the retrieved virtual coupon to a point of sale system, wherein the point of sale system is associated with a 3^{rd} party system.

12. The method of claim 11, wherein the communication of the retrieved virtual coupon is by NFC, IR, SMS, MMS, instant messaging, web browser based messaging, email, Enhanced Messaging System, TCP/IP, WAP, and/or barcode.

13. The method of claim 12, further comprising removing the retrieved virtual coupon after communication to the point of sale system; recording a fee based on a response to the at least one reply message; and recording a fee based on the communication of the retrieved virtual coupon to the point of sale system.

14. A method of notifying a user of a virtual coupon created from a physical coupon, comprising:
Scanning multi-modal artifact data from a multi-modal artifact;
Communicating at least some of the scanned multi-modal artifact data to a data repository;
Comparing the communicated data with data present in the data repository;
Sending at least one reply message from the data repository based upon the communicated data;
Storing a virtual coupon based upon the communicated data and a response to the at least one reply message; and
Providing a notification to the user of the stored virtual coupon when a condition is satisfied.

15. The method of claim 14, wherein the virtual coupon is stored in a digital device's local storage or is stored in a second data repository.

16. The method of claim 15, wherein the second data repository is tied to a user profile and is a digital coupon wallet.

17. The method of claim 14, wherein the condition is selected from the group consisting of: a date, a location of the user, a predicted location of the user, a second scanned multi-modal artifact, a user profile.

18. A system for creating a virtual coupon from a physical coupon, comprising:
A processor coupled to a mobile communication device;
A memory in communication with the processor and containing program instructions;
An input and output in communication with the processor and memory;
Wherein the processor executes program instructions contained in the memory and the program instructions comprise:
Receiving multi-modal artifact data scanned from a multi-modal artifact present in the physical coupon;
Communicating at least some of the multi-modal artifact data to a data repository;
Comparing the communicated data with data present in the data repository; and
Sending at least one reply message from the data repository based upon the communicated data.

19. The system of claim 18, wherein the multi-modal artifact comprises data being representative of at least one sensory input of visual, auditory, haptics, olfactory, or gustatory.

20. The system of claim 18, wherein the multi-modal artifact comprises data that is representative of a barcode, 2D code, 3D code, 3D-VR code, matrix code, data matrix, QR code, Near Field Communications (NFC) tag, Radio Frequency Identification (RFID) tag, Bluetooth, Infrared, and/or Wireless communication.
